(19) United States
(12) Patent Application Publication
(10) Pub. No.: US 2015/0033193 A1
(43) Pub. Date: Jan. 29, 2015

(54) METHODS FOR MODIFYING IMAGES AND RELATED ASPECTS

(71) Applicant: HERE Global B.V., LB Veldhoven (NL)

(72) Inventor: Jerome BEAUREPAIRE, Berlin (DE)

(73) Assignee: HERE Global B.V., LB Veldhoven (NL)

(21) Appl. No.: 13/950,827

(22) Filed: Jul. 25, 2013

(51) Int. Cl. G06F 3/0484; G06F 3/0488

(52) U.S. Cl. CPC G06F 3/04845; G06F 3/0488
USPC 715/863

(57) ABSTRACT

Examples are provided of methods and related aspects for presenting of an image on a display and causing modification of the displayed image by displaying at least one tear feature within the image responsive to detecting at least one edge tearing gesture applied to an apparatus. Some methods and related aspects partitioning the image into image portions using said at least one displayed tear feature and retaining a selected one of said image portions on the display. The retained image portion may then comprise a region of interest for which meta-data may be generated. Associating the meta-data with the file from which the image is generated enables the region of interest to be subsequently displayed without repeating the region of interest selection process.

The present disclosure provides some examples of embodiments of an invention relating to methods, apparatus, and computer products which use touch gestures for image modification and to related aspects.

Some disclosed embodiments of the invention use multi-touch gestures detected on an deformable apparatus to manipulate an image displayed on the apparatus or on a display associated with the apparatus. For example, multi-touch gestures determined to form a edge tearing gesture applied to the apparatus may be used to selectively crop an image to form a desired region of interest for the user.

The present disclosure further provides some examples of embodiments of the invention relating to modifying an image such as, for example, an image representing a map. By applying one or more tearing gestures to a deformable device, a displayed image may be modified and partitioned by a tearing feature, the tearing feature being formed in the image responsive to the tearing gesture. One portion of the partitioned image may be retained, and subsequently scaled to enlarge the region the retained image portion occupies on a display. The scaled and enlarged retained portion of the image may be defined as an area of interest using meta-data to enable subsequent retrieval of the defined area of interest.

Some disclosed examples of embodiments of the invention describe an area of interest being automatically generated after a retained portion of the partitioned image has been selected, for example, by automatically scaling the retained portion to the size of the area on the display previously occupied of the original image and/or automatically generating corresponding meta-data to enable subsequent retrieval of the area of interest.

Some disclosed examples of embodiments of the invention describe the display resolution and cropping settings for the resized image forming meta-data and being held in memory and/or associated with the data file for the original image so that subsequent selection of the image file causes only the area of interest to be provided and/or constrain zooming actions performed on the image to limit the displayed image resolution to that of the previously defined area of interest.

Many forms of gesture are already known in the art for image modification, for example, pinch to zoom in/out, swipe to delete an image, and the use of sheering gestures to segment images is already known in the art, as is the use of multi-touch inputs, such as bi-modal touch inputs, which are known to provide tearing gestures for image modification.

Deformable electronic devices are known in the art.

The use of deformable apparatus increases the ability of different types of gesture input to be detected through the user interface or man-machine interface of the apparatus. For example in addition to, or instead of, just using touch sensors arranged to detect user input to or over the surface of a device, deformable apparatus can use strain sensors to detect deformation of the physical structure. Such deformations may be applied to resilient apparatus which resist the deformation(s) applied by user input gesture (s).

Known image modification techniques to edit images providing visual information in the form of photographic, cartographic, bibliographic (e.g. text), and artistic images include touch input gestures applied to a touch-screen on which the image is displayed. Examples of such known image modification or manipulation techniques include pinching the touch-screen to zoom the image at the location of the touch-input on the display.

A particular issue may arise with some images where only a particular region of the image is of interest to a user at a given time. Examples of such images include high resolution images which can provide be displayed at a range of levels of magnification. Depending on the level of magnification of an image and the area on the display the image occupies, only a portion of the image may be visible at any one time. In this situation, a user may have to perform one or more zooming and scrolling/panning operations to locate a desired area of interest within a particular image and then may wish to cause the desired area of interest to be further magnified to a desired level and positioned to occupy a desired area on a display.

As higher-resolution images are provided, the ability to select and zoom in to a particular region is becoming more useful, particularly, for example, where a user is only ever interested in a particular portion of the image. A user may, for example, open an image of a map of a country, but then zoom to just show a particular region, town, or even street in the image. However, if the user wishes to exit the image viewing application and then subsequently wants to access that desired region of interest in the image again, the user may need to save the edited image with a new file designation, or revert back to the original image when they next access that image and duplicate the cropping and/or zooming steps that they previously performed to access the area of the image they are interested in.

Simplifying the process of selecting and zooming a particular region in an image is accordingly becoming more desirable. In particular, it is time-consuming for a user who is only ever interested in a particular portion of the image to have to repeatedly open the entire image and select to zoom to just the desired area of interest provided by a portion of the image each time they want to view the desired area of interest. Even where digital rights enable a user to save a desired area of interest in a separately retrievable image file, the result may be undesirable as it increases the amount of data held in storage on the device. A separate image file moreover may not provide a user viewing the desired area of interest with a simple option to remove the designation of the area of interest and revert back to the original entire image.

Accordingly, it is desirable if image modification or manipulation techniques can be made more intuitive for users, particular users of deformable devices. It is also desirable if modified images can be retrieved with a minimum increase of the amount of data stored on an electronic device.

### SUMMARY STATEMENTS

One example of an embodiment of the invention seeks to provide a method comprising:

causing presentation of a first image on a display; and causing modification of the displayed image by displaying at least one tear feature within the image responsive to detecting at least one edge tearing gesture applied to an apparatus.

Some examples of causing modification of the displayed image may comprise:

partitioning the image into image portions using said at least one displayed tear feature; and retaining a selected one of said image portions on the display.

In some examples, the retained image portion may comprise a region of interest for which meta-data may be generated. In some examples, the meta-data is associated with the file from which the retained image portion was generated to enable the region of interest to be subsequently displayed without repeating the region of interest selection process.

Some examples of the method may comprise: scaling the retained image portion to the same size on the display as a presented size on the display of the first image, responsive to the selection of the image portion to be retained.

Some examples of the method may further comprise: determining one or more characteristics of multiple touch inputs applied to said apparatus; and determining one or more characteristics of a said edge tearing gesture from said one or more characteristics of said multiple touch inputs.

In some examples of the method, one or more characteristics of said multiple touch inputs forming a said edge tearing gesture are detected at least in part by one or more strain sensors of the apparatus.

In some examples of the method, the characteristic of the magnitude of strain caused by a said edge tearing gesture may be sensed by said one or more strain sensors determines the magnitude of said tear feature in said image.

In some examples of the method, one or more characteristics of said multiple touch inputs forming a said edge tearing gesture may be detected at least in part using one or more pressure sensors of the apparatus.

In some examples of the method, a said edge tearing gesture may comprise at least two touch inputs applied to opposing sides of said apparatus.

In some examples of the method, the direction in which said tear feature propagates in the image may be determined from characteristics of at least one said detected edge tearing gesture and/or at least one user-configurable setting.

In some examples of the method, a plurality of said edge tearing gestures may be sequentially applied to said image prior to retaining a selected image portion.

In some examples of the method, said image may be partitioned by propagating the initial tear feature using at least one additional touch input.

In some examples of the method, the at least one additional touch input may comprise at least one additional edge tearing gesture.

In some examples of the method, the additional touch input may be provided by sensing a touch input applied to said tear feature in said image, and wherein the detected direction of said additional touch input determines the direction of propagation of said tear feature in said image.

Some examples of the method may further comprise: generating meta data defining characteristics of the retained image portion including any scaling applied to the retained image portion and defining the size of the retained image portion; and associating said meta data with data providing the image.

In some examples of the method, the apparatus may include the display on which the image is provided.

Some examples of the method may further comprise: dynamically propagating a said tear feature within said image dependent on one or more characteristics of a said edge tearing gesture.

Some examples of the method may further comprise: presenting a selectable option to determine an edge feature in said image said tear feature is to further propagate along within said image.

Another example of an embodiment of the invention seeks to provide an apparatus comprising a processor and a memory including computer program code, the memory and the computer program code configured to, with the processor, cause the apparatus to: cause presentation of a first image on a display; and cause modification of the displayed image by displaying at least one tear feature within the image responsive to detecting at least one edge tearing gesture applied to an apparatus.

In some examples of the apparatus, the display is a component of the apparatus. In other examples of the apparatus, the display may be a component of another apparatus. In some examples, the apparatus comprises a chip-set or other form of discreet module.

In some examples of the apparatus, the memory and the computer program code may be configured to, with the processor, cause the apparatus to cause modification of the displayed image by: partitioning the image into image portions using said at least one displayed tear feature; and retaining a selected one of said image portions on the display.

In some examples of the apparatus, the memory and the computer program code may be configured to, with the processor, further cause the apparatus to scale the retained image portion to the same size on the display as a presented size on the display of the first image, responsive to the selection of the image portion to be retained.

In some examples of the apparatus, the memory and the computer program code may be configured to, with the processor, cause the apparatus to: determine one or more characteristics of multiple touch inputs applied to said apparatus; and determine one or more characteristics of a said edge tearing gesture from said one or more characteristics of said multiple touch inputs.

In some examples of the apparatus, the memory and the computer program code may be configured to, with the processor, cause the apparatus to detect one or more characteristics of said multiple touch inputs forming a said edge tearing gesture at least in part by one or more strain sensors of the apparatus.

In some examples of the apparatus, the memory and the computer program code may be configured to, with the processor, cause the apparatus to determine the magnitude of strain sensed by said one or more strain sensors and to determine the magnitude of said tear feature in said image in dependence on the sensed magnitude of strain.

In some examples of the apparatus, the memory and the computer program code may be configured to, with the processor, cause the apparatus to detect said one or more characteristics of said multiple touch inputs forming a said edge tearing gesture at least in part using one or more pressure sensors of the apparatus.

In some examples of the apparatus, the memory and the computer program code may be configured to, with the processor, cause the apparatus to determine the direction in which said tear feature propagates in the image from at least one of: one or more characteristics of a said detected edge tearing gesture; and one or more user-configurable settings.

In some examples of the apparatus, the memory and the computer program code may be configured to, with the processor, cause the apparatus to: detect a plurality of said edge tearing gestures sequentially applied, wherein after at least one said edge tearing gesture, a plurality of selectable image portions are retained on the display when at least one subsequent edge tearing gesture is applied.

In some examples of the apparatus, the memory and the computer program code may be configured to, with the processor, cause the apparatus to: detect at least one additional touch input after said edge tear gesture has caused said tear image feature in said first image; and propagate the tear feature in the image responsive to the at least one additional touch input.

In some examples of the apparatus, the at least one additional touch input may comprise at least one additional edge tearing gesture.

In some examples of the apparatus, the memory and the computer program code may be configured to, with the processor, cause the apparatus to: determine the additional touch input comprises a touch input is applied to said displayed tear feature in said image; and determine the direction of said detected additional touch input; and cause the propagation of said tear feature in said image in dependence on the determined direction of said detected additional touch input.

In some examples of the apparatus, the memory and the computer program code may be configured to, with the processor, cause the apparatus to: generate meta data defining characteristics of the scaled retained image portion; and associate said meta data with data providing the image.

In some examples of the apparatus, the metadata may comprise one or more of: a scaling applied to the retained image portion; a size definition of the retained image portion; a location of the retained image portion on the display; coordinates of the corners of the retained image portion in the first image; coordinates of the corners of the retained image portion on the display; a zoom level for the retained image portion as resized on the display; a zoom level at which the first image was manipulated; a map mode used for the retained image portion; a layer information for the retained image portion; data file information; and image version information.

Another example of an embodiment of the invention seeks to provide apparatus comprising: means for causing presentation of a first image on a display; and means for causing modification of the displayed image by displaying at least one tear feature within the image responsive to detecting at least one edge tearing gesture applied to an apparatus.

Some examples of the apparatus may comprise means to perform an example of an embodiment of a method aspect as set out herein and as claimed in the accompanying claims.

Another example of an embodiment of the invention seeks to provide a computer program product comprising a non-transitory computer readable medium having program code portions stored thereon, the program code portions configured, upon execution, to: cause presentation of a first image on a display; and cause modification of the displayed image by displaying at least one tear feature within the image responsive to detecting at least one edge tearing gesture applied to an apparatus.

Some examples of the computer program product may comprise means to perform an example of an embodiment of a method aspect as set out herein and as claimed in the accompanying claims.

Another example of an embodiment of the invention seeks to provide a method comprising: causing presentation of a first image provided by a data file on a display;

causing modification of the displayed image by displaying at least one tear feature within the image responsive to detecting at least one tearing gesture applied to an apparatus; partitioning the image into image portions using said at least one displayed tear feature; retaining a selected one of said image portions on the display; and presenting an option to generate meta-data to regenerate the selected image portion on the display, said meta-data being configured to enable subsequent regeneration of said selected image portion from the data file used to present the first image.

The above aspects and accompanying independent claims may be combined with each other and/or with one or more of the above embodiments and accompanying dependent claims in any suitable manner apparent to those of ordinary skill in the art.

### BRIEF DESCRIPTION OF THE DRAWINGS

Some examples of embodiments of the invention will now be described using the accompanying drawings which are by way of example only and in which:

FIG. 1A shows an schematic diagram of an example of apparatus according to an embodiment of the invention;

FIG. 1B shows an schematic diagram of another example of apparatus according to an embodiment of the invention;

FIG. 2A shows a schematic diagram of an example of a display provided in the example of the apparatus shown in FIG. 1a;

FIG. 2B shows a schematic cross-sectional view of the display shown in FIG. 2a;

FIGS. 3A, 3B, and 3C show schematically examples of the flexibility of a deformable apparatus according to an example of an embodiment of the invention.

FIG. 4 shows schematically examples of sensor regions which may be provided on an deformable apparatus according to an example of an embodiment of the invention;

FIG. 5 shows schematically the location of sensed touch inputs forming a sheering gesture;

FIGS. 6A and 6C show schematically the location of sensed touch inputs applied to the front of deformable apparatus according to first and second examples of edge tearing gestures according to embodiments of the invention;

FIGS. 6B and 6D show schematically the location of sensed touch inputs applied to the rear of an deformable apparatus according to first and second examples of edge tearing gestures according to embodiments of the invention;

FIGS. 7A to 7E show schematically examples of how tearing gesture applied to an deformable apparatus according to an example of an embodiment of the invention can strain the deformable apparatus;

FIG. 8A shows schematically an example of a deformable apparatus according to an embodiment of the invention being caused to provide several images on a display;

FIG. 8B shows schematically an example of a deformable apparatus according to an embodiment of the invention being caused to provide a image substantially occupying the entirety of a display;

FIG. 9A shows schematically an example of a tear gesture applied to apparatus device according to an example of an embodiment of the invention.

FIG. 9B shows an example of how an initial tear feature displayed may be further modified;

FIGS. 10A to 10C show schematically an example of image modification according to an example of an embodiment of the invention;

FIGS. 11A to 11C show schematically another example of image modification according to another example of an embodiment of the invention;

FIGS. 12A to 12C show schematically another example of image modification according to an example of an embodiment of the invention;

FIGS. 13A to 13E show schematically another example of image modification according to an example of an embodiment of the invention;

FIG. 14 shows schematically an enlarged view of the image which is shown manipulated in FIGS. 13A to 13E;

FIGS. 15A to 15D show schematically examples of how an tear feature applied to an image may be modified in some examples of embodiments of the invention;

FIGS. 16A-16C show schematically respective examples of methods of image modification according to various embodiments of the invention; and

FIG. 17 shows schematically meta-data generation according to an example of embodiment of the invention.

In the following description, for the purposes of explanation, numerous specific details are set forth in order to provide a thorough understanding of some examples of embodiments of the invention. It will be apparent to one of ordinary skill in the art, however, that other embodiments of the invention may be practiced without these specific details or with an equivalent arrangement. Accordingly, the drawings and following description are intended to be regarded as illustrative examples of embodiments only and, as such, functional equivalents may exist which, for the sake of clarity and for maintaining brevity in the description, cannot necessarily be explicitly described or depicted in the drawings. Nonetheless, some such features which are apparent as suitable alternative structures or functional equivalents to those of ordinary and unimaginative skill in the art for a depicted or described element should be considered to be implicitly disclosed herein unless explicit reference is provided to indicate their exclusion. In other instances, well-known structures and devices are shown in block diagram form in order to avoid unnecessarily obscuring the examples of embodiments of the invention. Like reference numerals refer to like elements throughout.

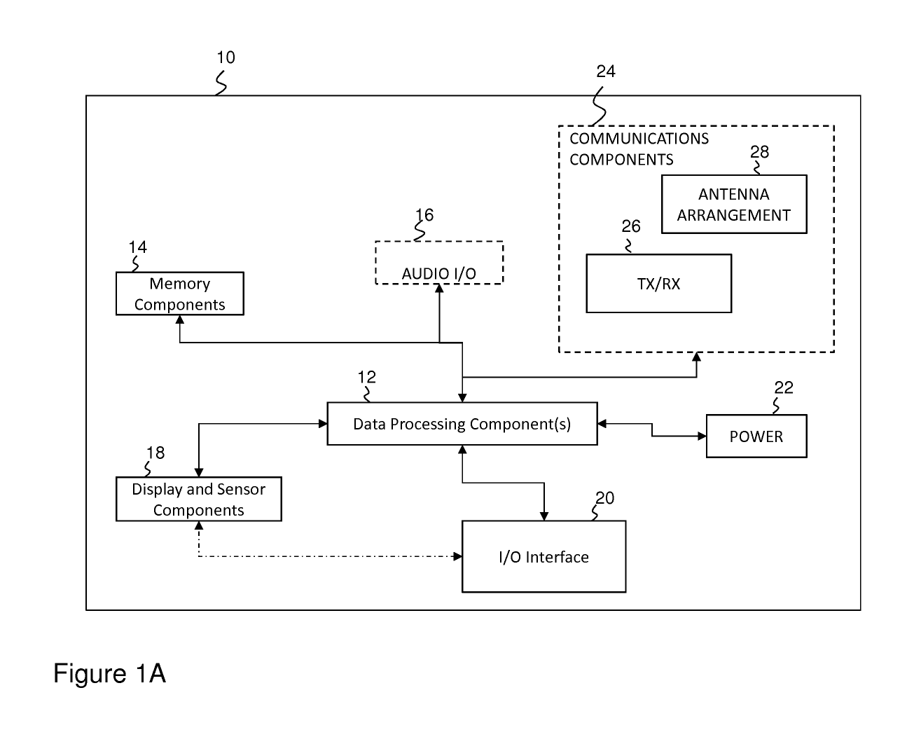

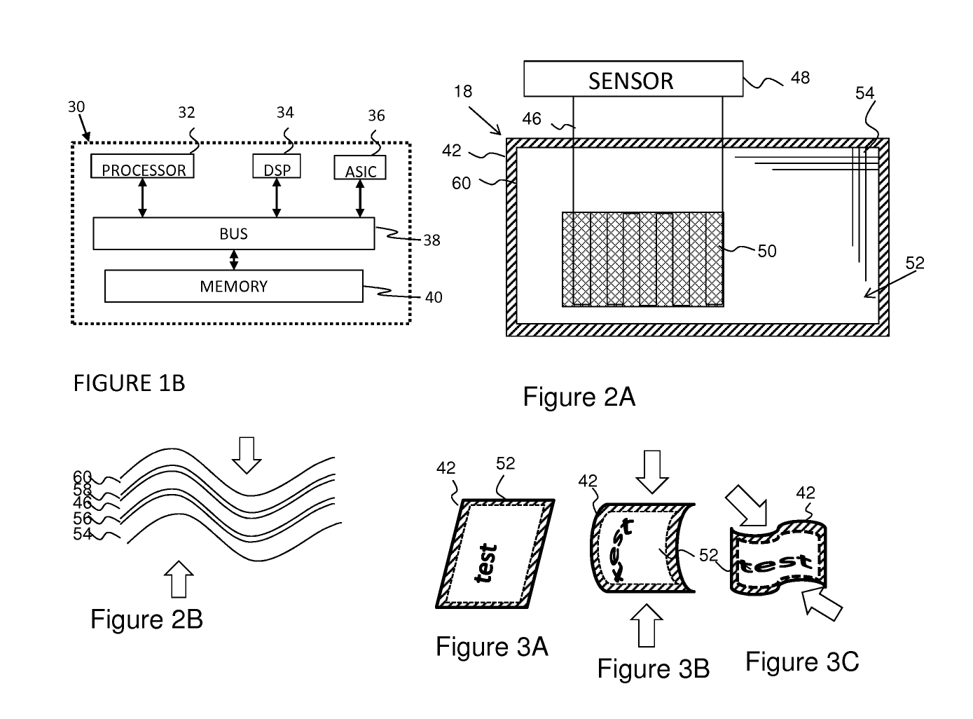

FIG. 1A of the accompanying drawings shows schematically some functional components of a user-operable deformable apparatus 10 according to an example of an embodiment of the invention. In FIG. 1A, apparatus 10 comprises a plurality of components forming an electronic device according to an example of an embodiment of the invention. Examples of apparatus providing embodiments of the invention include apparatus 10 comprising deformable user-operable devices, for example, electronic devices or terminals characterized by having functionality such as fixed or mobile communications, image capture functionality (video or still images), computing functionality, remote control functionality for providing control signals to other apparatus including display apparatus using wired and/or wireless communications. Examples of such apparatus 10 include mobile phones, feature phones or smart phones, toys, cameras, camcorders, computers, personal digital assistants, tablets, and also appliances and apparatus used as remote controls for televisions or other remote displays.

In some embodiments, however, the apparatus may be embodied as a chip or chip set, such as the apparatus 30 shown in FIG. 1B. In other words, examples of deformable apparatus may comprise one or more physical packages (e.g., chips) including materials, components and/or wires on a structural assembly (e.g., a baseboard). The apparatus may, in some examples, be configured as a single chip or as a single “system on a chip.” As such, in some cases, a chip or chipset may constitute means for performing one or more operations for providing the functionalities described herein. An example of a chip-set embodying the invention is shown in FIG. 1B. FIG. 1B shows schematically an apparatus 30 which may be used as a component of apparatus 10. Apparatus 30 may, for example, comprise an electronic chipset. The apparatus 30, when suitably provided in an electronic device, may causes the electronic device to function as an apparatus 10 according to an example of an embodiment of the invention shown in FIG. 1A. FIG. 1B is described in more detail later.

In some examples, the structural assembly of the deformable apparatus is capable of being subject to distortion responsive to user input and such distortion causes a strain which the apparatus as a whole is capable of detecting and processing as user input.

As shown in FIG. 1A, apparatus 10 comprises a suitable data processing component(s) 12 and memory 14 which comprises at least read-only memory (ROM) and random access memory (RAM) components. The memory 14 may include removable memory components in addition to any components integrated for use with a processing component, for example, in some embodiments of the invention, the additional memory components may include flash memory and the like.

In some examples of embodiments, the processor component(s) 12 (and/or co-processors or any other processing circuitry assisting or otherwise associated with the processor 12) may be in communication with memory 14 in the form of a memory device via a bus for passing information among components of the apparatus 10. The memory device may be non-transitory and may include, for example, one or more volatile and/or non-volatile memories. For example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

In some examples of embodiments, the processor 12 may be configured to execute instructions stored in the memory device 14 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a mobile terminal or a fixed computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Apparatus 10 also comprises display 18a and sensor 18b components 18, for example, in the form of a touch-screen, a suitable input/output interface 20 which may be configured to receive inputs from the sensor components 18b, including sensor components of a touch-screen and/or strain sensors. In some examples of embodiments, strain sensors may be located independently of the display and/or touch sensors. In some examples of embodiments, input may be determined independently from any touch-related sensor input. Also shown in FIG. 1A is a suitable power supply 22, which for portable apparatus may include portable battery components, and/or a port for receiving power from an external supply.

As shown in FIG. 1, apparatus 10 may additionally have optional components such as audio input and output components 16, and/or communications components 24 which need not be provided in all embodiments. Examples of apparatus 10 comprising wireless communication devices include communications components such as a suitable antenna arrangement 28 and/or transmitter/receiver component 26, which may in some embodiments be controlled by processor 12 but which may in some embodiments be controlled by a separate processor (not shown). Examples of communications components 24 include wireless communications components configured to use wireless communications networks, including cellular networks such as, for example, cellular data packet networks (GSM, GPRS, CDMA, WDMA, UMTS, 3G and/or LTE networks) and wireless local area networks, for example, 802.11x (Wi-Fi) type and/or 802.16x (WiMax) type networks. In some embodiments of the invention, short-range radio communications may also be supported, such as infra-red communication, or personal or ad-hoc communications, such as, for example, communications conform to the ZigBee™ personal network and/or Bluetooth™ network communication protocols, and/or near-field communication (NFC) communication protocols. Fixed communications components may enable connection to local area networks (e.g. Ethernet), or to optical networks, or to the public switched telephone network (PSTN).

Some examples of apparatus 10 are deformable in the sense that the physical structure of the apparatus 10 is affected by forces applied to the apparatus 10 which change the physical dimensions of the apparatus 10. Such forces may cause deformation to occur concurrently in a plurality of different ways, for example, deformation of the apparatus 10 may result from compressing the surface of the apparatus 10 and/or deformation of the apparatus 10 may result from forces applied to apparatus which bend, flex, stretch, elongate or otherwise distort the structure of the apparatus 10. As an example, a compressive force may be applied by a touch gesture to a surface of the apparatus 10 which distorts the apparatus 10 by bending the apparatus as a whole. Deforming forces may generate strain in the apparatus 10. The apparatus 10 may be resilient and revert back elastically to its original structure when the applied deforming force is removed or remain deformed to some extent.

The components of apparatus 10 (including optional components) may be individually flexible and/or deformable and/or be mounted or connected in a suitably flexible manner to allow deformation of the apparatus 10. As shown in FIG. 1A, deformable apparatus 10 comprises internal components 14-24 which may be formed themselves flexibly and/or which may be flexibly housed by one or more flexible housing members. A flexible housing member may include both flexible and inflexible internal components, for example, WO2013/048925 describes some examples of flexible electronic devices of a type similar to the type of apparatus 10 in which a strain sensor, for example, of the type described in WO2009/095302, may be provided to detect deformation of the structure of the device, The components shown in apparatus 10 may be implemented using circuitry and may form software, hardware, firmware or a combination thereof

FIG. 1B of the drawings show an example of apparatus 30 comprising a component module such as a chipset which may be used as a component of an apparatus 10 in some examples of embodiments of the invention. The components shown forming apparatus 30 may include at least one processor 32, at least one memory 40 which together with appropriate computer code, which may configure the apparatus 30 to cause an apparatus 10 to implement an example of an embodiment of the invention.

Apparatus 30 according to another example of an embodiment of the invention as shown in FIG. 1B will now be described in more detail. As shown schematically in FIG. 1B, the apparatus 30 may be provided as chip-set. The apparatus 30 includes a suitable communication mechanism such as a bus 38 for passing information among the components of the apparatus 30. At least one processor 32 is provided (which may comprise in some embodiments the processor 12 shown in FIG. 1A), and this has connectivity to the bus 38 to execute instructions and process information stored in, for example, a memory 40 (which may comprise in some embodiments the same memory component 14 shown in FIG. 1A). The processor 32 may include one or more processing cores with each core configured to perform independently, so that a multi-core processor enables multiprocessing within a single physical chip set. Alternatively or in addition, the processor 32 may include one or more microprocessors configured in tandem via the bus 28 to enable independent execution of instructions, pipelining, and multithreading. Specialized components 34, 36 shown in FIG. 1B may be provided in apparatus 30 to perform certain processing functions and tasks, however, in other embodiments, these functions and tasks may be performed partly or entirely by processor 32 (or alternatively, partly or entirely by processor 12 when the chip-set component 30 is integrated into apparatus 10). As shown in FIG. 1B, however, the specialized components comprise one or more digital signal processors (DSP) 34 and one or more application-specific integrated circuits (ASIC) 36. A DSP 34 typically is configured to process real-world signals (e.g., sound) in real time independently of the processor 32. ASIC 34 may be configured to performed specialized functions not easily performed by a general purpose processor. Other specialized components which may in some embodiments of the invention also be provided to aid in performing the functions described herein including one or more field programmable gate arrays (FPGA) (not shown), one or more controllers (not shown), or one or more other special-purpose computer chips. The processor 32 and accompanying components 34, 36 have connectivity to at least one type of memory 40 via the bus 38. The memory 40 may be implemented by a dynamic memory (e.g., RAM, magnetic disk, writable optical disk, etc.) and/or static memory (e.g., ROM, CD-ROM, etc.) and is arranged to store executable instructions that when executed perform the steps of any method embodiments of the invention described herein.

FIG. 2A of the accompanying drawings shows an example of the display components 18a and sensor component(s) 18b of a deformable apparatus 10 in more detail. In FIG. 2A, the display/sensor component 18a,b comprises a touch-sensitive screen or touchscreen 18. Examples of touchscreen 18 include touchscreens which are configured to detect touch input applied to the surface of the touchscreen and/or to touchscreens which are configured to detect touch inputs in the proximity, such as hovering, over the surface of the touchscreen. Touch input may be provided by any suitable touch input element, including but not limited to a body part such as a digit (thumb or finger), a palm, wrist, tongue or other limb, or stylus or the like. Some examples of deformable apparatus 10 use a deformable and flexible touchscreen 18.

FIG. 2A shows an example of a touchscreen 18 implemented as a display 52 which includes an array of picture elements (for example, pixels) 54 configurable to show images on the display 52. A frame region or bezel or non-touch responsive region 42 is shown extending around the periphery of the display 52.

In some embodiments, the picture elements 54 extend into frame region 42, however, in some embodiments of the invention, no bezel or frame is provided. In some embodiments, the display 52 and/or the picture elements 54 may extend around the surface of apparatus 10 to cover more than one side of the device. In some embodiments, for example, the display may wrap around the surface of the apparatus to include the edges of the apparatus 10 and/or be provided on the rear surface of apparatus 10 as well as the front surface. In some embodiments the entire surface of apparatus 10 may be provided with display 52 and picture elements 54 co-incident with touch sensors, whereas in some embodiment the entire surface of apparatus 10 may be provided with display 52 but the picture elements and/or touch sensitive sensors may not extend over just a portion of the surfaces of apparatus 10.

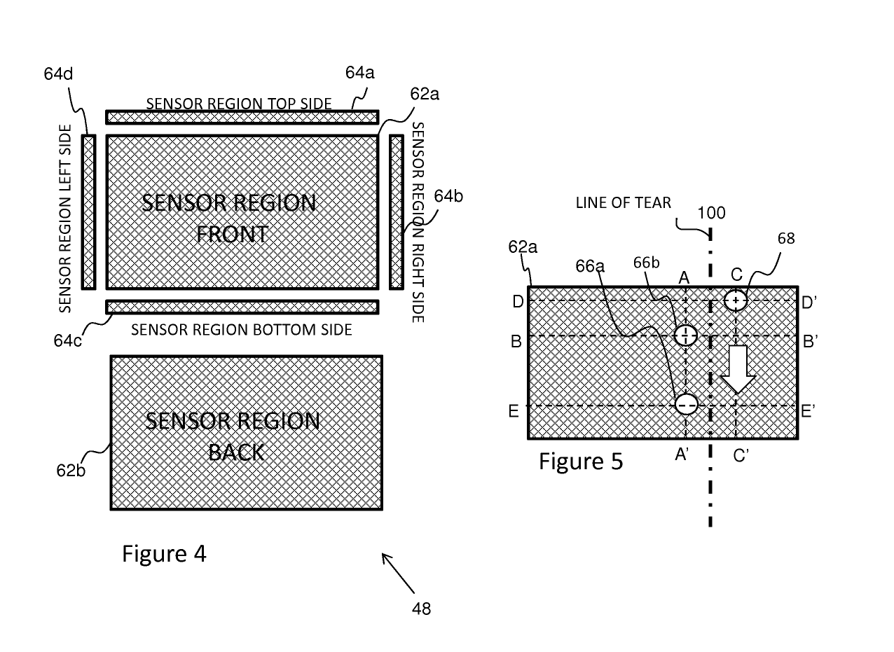

As shown in FIG. 2B, an example of a sensor 48 includes a substantially transparent member 60 which extends over at least a portion of the array of picture elements 54. One or more types of touch input sensors 48 may be provided in such a way that various characteristics of touch inputs applied to the front and/or rear sides and/or on the edges of apparatus 10 are detectable (see FIG. 4, described in more detail herein below). The touch input sensors 48 need not always be associated with the display 52, as, for example, one or more strain sensors may be located at appropriate points within apparatus 10 not necessarily located within display 52.

As shown schematically in FIG. 2A, the sensor 48 comprises a conductive member 46 has an appropriately configured conductive track (other track configurations may be used to that shown in FIG. 2A). Sensor 48 may comprise any suitable material enabling apparatus 10 to detect touch inputs, such inputs including surface touch inputs or hover touch inputs over a surface. In some embodiments of the invention, a substantially transparent conductive material such as indium tin oxide, aluminum doped zinc oxide or a conductive polymer such as Poly(3,4-ethylenedioxythiophene) or Poly(3,4-etheylenedioxythiophen)poly(styrenesulfonate) may be used to form the conductive track 46 of sensor 48. The positioning of the sensor circuitry shown in FIG. 2A is shown for schematically outside of the display region for the purposes of clarity, and should not be considered to confer any limitation on the location, arrangement or configuration within the apparatus of any sensor(s).

FIG. 2B shows schematically a cross-sectional view through the surface of an example of a deformable touch-screen component 18 of an apparatus 10. In FIG. 2B, the touch sensor track 46 shown in FIG. 2A is shown as being implemented in a layer overlying a layer comprising picture elements 54 forming display 52. As shown, the sensor track layer 46 is coupled to the picture elements 54 forming display 52 by an adhesive layer 56 as shown in FIG. 2B. In some examples of embodiments of apparatus 10, the sensor 48 and the display elements 54 may be integrated with each other, for example, provided as a monolithic structure or otherwise suitably fused together. As shown in FIG. 2B, a transparent protective surface layer 60, formed of a suitable resilient material such as plastic, is provided to overlay the sensor and adhered thereto using a suitable adhesive layer 58. In some embodiments, it may also be possible to dispense with the surface layer 60 and adhesive layer 58, if the sensor 38 is integrated into a suitable material. As shown in the example of an embodiment of a touchscreen in FIG. 2B, the overlying layers 60, 58, 44, and 56 are transparent so as to enable a user to view the picture elements 54 of display 52.

Apparatus includes at least one strain sensor operable to sense a deformation causing strain on the structure of apparatus 10. However, in some embodiments, the strain sensor may be differently located and operate independently of the touch input sensed by sensors 18b associated with the touchscreen 18. In such embodiments, additional processing is performed on the signals generated by the strain sensor responsive to touch input being applied to strain the device to associate the input with the touch input sensed by touchscreen 18 sensor 38 which locates where the user has held the apparatus.

In FIG. 2A, a strain gauge sensor 38 is operable to sense the force applied to the apparatus 10 either independently or in conjunction with any other sensors associated with the touch screen which are able to detect touch input by a user of apparatus 10. Examples of such touch sensors may include capacity sensors capable of sensing the pressure applied by touch input and be capable of sensing multi-touch input. The touch input here may be applied by a touch-input element such as a digit (finger, thumb, or toe) or other suitable body part, or by a stylus or the like. In one example of an embodiment of the invention, to apply a strain a user grips the apparatus 10, and as such the touch input sensor and strain sensors operate in co-operation to detect the characteristics such s the type of gesture, the location of inputs, and any strain applied by the user's grip causing deformation of the apparatus. In some embodiments of the invention, the surface of display 52 may not be directly compressible responsive to touch input, although the apparatus 10 as a whole may be deformed as a result of the way the user manipulates the apparatus 10 and accordingly internal to the device strain sensors may also detect the strain caused by deforming the apparatus 10.

FIG. 3A shows schematically, and by way of example only, a rectangular form which an example of a deformable apparatus 10 may adopt when the apparatus 10 is not subject to deforming forces according to an example of an embodiment of the invention. FIGS. 3B and 3C show, by way of example only, how the apparatus 10 shown in FIG. 3A may be deformed to adopt a distorted structural state by applying force to the surface of the apparatus 10 in the directions shown by the arrows. This deformation of apparatus 10 may alter one or more characteristics of the conductive member 46 of strain sensor 48 shown in FIG. 2A.

In some embodiments, the extent of the altered characteristics of the strain sensor resulting from the deformation of the apparatus, enables characteristics of the applied deforming forces to be deduced, such as the location of the touch inputs producing the deforming forces, the size or magnitude of deformation caused by said touch inputs at particular locations on the apparatus, the direction of the force(s) applied to the apparatus, and also whether a recognized gesture such as an edge tearing gesture has been applied by a user to deform apparatus 10.

For example, reverting back to FIG. 2B briefly, when a user compresses surface layer 60, this in turn compresses conductive member 46 of sensor 48. In one example of apparatus 10, when the conductive member 46 is deformed by strain or compressive forces, it changes the electrical resistance of the conductive member 46, and this is detected using suitable means known in the art. The strain detected by sensor 38 is suitably processed and output as a control signal, for example, to the data processing component 12 shown in FIG. 1A or to processing component 32 shown in FIG. 1B.

As previously mentioned, in some embodiments of apparatus 10, a plurality of sensors of the same or different type may be provided in a layered configuration (i.e., one sensor layer on top of another sensor layer), or integrated substantially with the same layer. For example, another strain sensor may be provided with a different serpentine configuration, or alternatively, other type or types of sensor (s) may be provide, for example a capacitive touch sensor, a surface acoustic wave (SAW) sensor, an optical imaging sensor, a dispersive signal technology sensor, an acoustic pulse recognition sensor, a frustrated total internal reflection sensor and/or a resistive sensor. Such sensors are well known in the art and are not further described herein. The provision of such sensor may add to the number of layers shown in FIG. 2B in some examples of embodiments of the invention. Some examples of apparatus 10 include a flexible display 52 formed from one or more flexible layers.

Some examples of embodiments of apparatus 10 may be provided in addition to a flexible touch-sensitive display 52 with flexible user interface components such as flexible buttons, flexible audio input/output components such as flexible microphones, speakers etc.). In some examples of embodiments of apparatus 10, piezoelectric actuators may be provided and/or actuators for providing tactile feedback to users such as vibrators, pressure sensors etc. One or more sensors 48 may be provided out of flexible components for sensing the deformations of the device and for sensing other forms of input. Flexible surface layers and/or support layers may be provided in some embodiments of the invention. In some examples of embodiments, frame 42 of apparatus 10 is provided using a flexible material, in other examples of embodiments of apparatus 10, no frame component is provided. Internally, flexible components may be used for providing electrical circuits, such as by using printed circuit “boards” (PCBs) provided on a flexible substrate, for example such as apparatus 30 may comprise. Similarly, in some embodiments, the power component 22 is provided by flexible battery components, which may be provided as batteries having flexible and rigid portions (for example, batteries formed from multiple rigid portions joined in a flexible joint) or be provided by flexible battery layers. Flexible housing members may also have both rigid and flexible portions, or housing members that are substantially all flexible. Flexibility of the apparatus may be directional, such that a flexibility is provided in one dimension but not in another, and/or the degree of flexibility may differ between the dimensions of the housing member. Flexible housing members may be deformable to adopt more than one stable configuration.

Flex sensing components such as the strain sensor(s) described hereinabove may enable detection of user input comprising one or more of the following: applied torque to the apparatus 10, compression of the apparatus 10, elongation in one or more directions to stretch the apparatus 10, and sheering of a surface of the apparatus 10.

In some examples, user interface components of apparatus 10 may be provided on display 52 and the deformable nature of the surface of the display may enable a user to interact with the user interface using strain gestures. Sensor components of apparatus 10 may be configured to detect deformations of some part or all of the apparatus, such as actively twisting, squeezing, bending or otherwise distorting the apparatus 10, and associate such user input with a particular user interface action or functionality. For example, a user may flex apparatus 10 in one direction to refresh the screens state of an application shown on display 52

In some examples of embodiments of the invention, software and/or hardware may provide rules to assess the characteristics of detected touch inputs so as to identify if the touch inputs form, in some examples in conjunction with detected strain inputs, a particular touch input gesture. A touch-input gesture may correspond to stationary or non-stationary, single or multiple, touches or near touches of fixed or varying pressure, applied to or over the surface of display 52 (for example, to or over the window layer 60). A touch-input gesture with a strain component may be performed by a touch input element such as a first, palm, finger, toe or other body part, and may be performed by a plurality of touch input elements, such as by applying more than one figure or a combination of at least one figure or thumb, or a palm. In some examples of embodiments of the invention, the one or more touch input elements may move over the touch-sensitive screen in a manner that generates gestures such a tapping, pressing, rocking, scrubbing, twisting, tearing, changing orientation, pressing with varying pressure, hovering, and the like concurrently (i.e., at essentially the same time), or consecutively. A gesture may be characterized by, but is not limited to, pinching, sliding, swiping, rotating, flexing, dragging, tapping, twisting or tearing motion determined from the detected location one or more input elements on a display and/or the detected locations of one or more touch inputs relative to any one or more other input element(s), and/or to groups of touch inputs, or any combination thereof. Examples of detectable gestures include detecting the static grip or movement of one or more input elements, a group of input elements (e.g. the digits on a hand), which are usually provided by one user but which may be provided by one or more users, or any combination thereof. One example of an edge tearing gesture corresponds to the input detected when apparatus 10 is subject to strain about or around an edge of the apparatus 10 responsive to a user manipulating apparatus 10 through touch. In one example, the gesture emulates the gesture applied when a user attempts to tear the edge of a piece of card or paper.

FIG. 4 of the accompanying drawings shows schematically examples of a sensor 48 provided on an apparatus 10 according to an example of an embodiment of the invention. The sensor 48 may extend over more than one region and/or surface of apparatus 10. For example, as shown in the example of apparatus 10 in FIG. 4, sensor 48 comprises a plurality of sensor regions 62a,b,c,d and 64a,b shown in this example as being provided on the front of the apparatus 10 (62a), at the rear of the apparatus 10 (62b), and also at the top (64a), bottom (64c), and side edges (64b,d) of the apparatus 10. It will be appreciated that sensors do not need to be so extensively provided for other examples of apparatus 10, and that in some examples of apparatus 10, one or more of the regions shown in FIG. 4 may not be distinguishable from one or more other regions (e.g. if the apparatus 10 is spherical or otherwise substantially curved in from). The term “front” in reference to apparatus 10 as used herein refers to the side of the apparatus 10 generally proximate to a user operating the apparatus, which may or may not be the same side as the primary display of the apparatus 10.

The term tearing gesture as used herein refers to a specific combination of detected user inputs applied to apparatus 10 from which at least an line of tear 100 can be deduced. One example of a tearing gesture which may be used to implement an example of image modification according to an embodiment of the invention may be provided purely by touch input applied to the touch-sensitive surface of apparatus 10 being determined as indicative of a desired planar sheering effect on an image provided on the touchscreen surface. The touch inputs are processed by apparatus 10 and if they conform with certain criteria they produce an image of sheering line effectively producing a rip or tearing of the image to which the touch input has been applied.

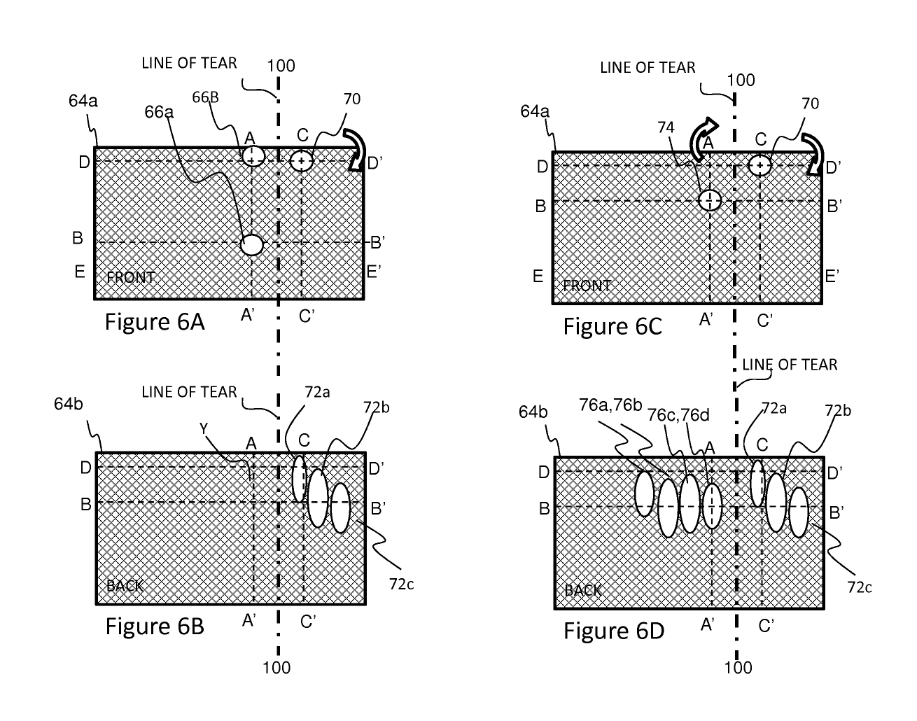

FIG. 5 shows an example of such a planar sheering type of tearing gesture which is sensed by a first touch-sensitive region 62a of an apparatus. No image is shown on the display region 52 underlying sensor region 62a for reasons clarity in FIG. 5 (and also in FIGS. 6A and 6C).

In FIG. 5, the touch inputs sensed may also include hover and touch inputs, which may be sensed by touch sensors and proximity (or hover sensors). In the example shown in FIG. 5, input 66a is sensed at the intersections of A-A′ with E-E′ and input 66b at the intersection of A-A′ with BB′ (the two touch inputs 66a,b being are sensed along a first line A-A′). Just one touch input 68 is sensed at the intersection of C-C′ and D-D′ by sensor region 62a. Sensor 48 then outputs the sensed signals from the inputs to a suitable processing component, for example, processor 12 or to the equivalent chip processor 32, and using appropriate software code, the sensed input signals can be processed to determine that a sheering line or line or tear 100 should be located parallel to and between lines A-A′ and lines C-C′. The precise location of the line of tear 100 may be determined using appropriate rules, and may be more proximate to A-A′ than to C-C′ depending on the nature of the inputs sensed and/or how the apparatus 10 has been configured.

In some examples of embodiments, the number of inputs provided along A-A′ may different, as may the number of inputs along C-C′. In some examples of embodiments, the more touch inputs which are detected, the more precise the desired line of tear is likely to be, emulating the way a real thin planar surface object, such as paper or tissue, may be torn more carefully if it is held more securely. The direction in which the inputs move need not be parallel, for example, the inputs could be diametrically moved apart to produce a more rip-tear line rather than a sheer tear line.

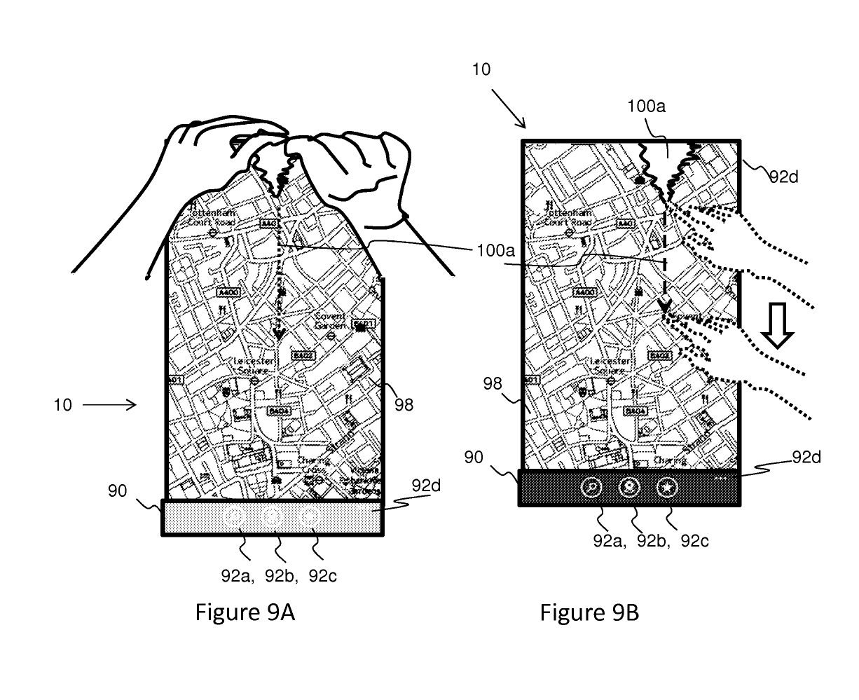

Based on the line of tear which the detected tearing input gesture defines, an image provided on the display 52 may be modified by a tearing feature 100a which follows the determined line of tear 100 (not shown in FIG. 5, see FIG. 9A for example). In some examples, the more loose or light the touch input is sensed to be, the more erratic the tear feature 100a provided on the image provided on display 52 (not shown in FIG. 5).

In the example shown in FIG. 5, the touch points 66a,b along A-A′ are static, and input 66 moves in the direction of the arrow towards C′, however, it is also possible to produce a similar line of tear 100 from the same edge of the image, by holding touch input 66 still, and moving inputs 66a, 66b towards A′. An enlarged single input such as the palm of a hand may also be used, for example, to replace inputs 66a,66b, and/or input 68. As shown in FIG. 6, the resulting touch input gesture determined from the inputs is processed to provide a line of sheer or a tear 100. For more examples of how multi-point touch inputs, often referred to as bi-modal touch inputs are known may provide tearing gestures for image modification, see, for example, United States Patent Application US2011/0185318, entitled “Edge Gestures” and European patent application EP2241963, entitled “Information Processing Apparatus, Information Processing Method and Program”.

FIGS. 6A to 6D show schematically examples of how different multi-touch inputs may be detected as forming an edge tearing gesture. In some examples, an edge tearing gestures is detected when a deformable apparatus 10 which includes suitable strain sensors 48 capable of detecting strain applied by a user deforming the apparatus 10, determine that the touch inputs detected at a certain locations are applying strain to an edge of the apparatus 10. In some examples of embodiments of the invention, the characteristics of the inputs sensed by apparatus 10 as providing the edge tearing gesture may determine one or more characteristics of a tear feature to be applied to modify an image on a display. In some embodiments, the display is part of sensor/display input component 18 of apparatus 10 but alternatively, in other examples of embodiments of the invention, the display may be provided independently, for example, by a different device configured to receive control information from apparatus 10.

Examples of characteristics of touch input applied to apparatus 10 include, but are not limited to: the position of each detected touch input relative to one or more other detected touch inputs; the position of each detected touch input relative to an edge of the image to which the tear is to be applied or to a feature shown within the image to which the tear is to be applied; the detected direction of any dragged or swiped input; the determined relative direction of movement one or more touch inputs to the position and/or direction of movement of one or more other touch inputs, the speed of detected movement of one or more touch inputs, the speed of movement of one or more touch inputs relative to each other, the sensed pressure associated with one or more touch inputs, the pressures of each touch input relative to the pressure of other touch inputs, and any combination of such characteristics. One or more of the characteristics of the touch input determined to form an edge tearing gesture may determine one or more characteristics of the tearing feature as it appears within an image shown on the display of the apparatus 10. The characteristics of the tearing feature which may be determined this way include one of more dimensions of the tearing feature and/or the form of the image representing the tearing feature (for example, the size of any jagged edges to the tear feature shown in the image).

FIGS. 6A and 6B, show one example of such a tearing gesture applied when a user places a deformable apparatus 10 down on a surface and holds it down with one hand, whilst flexing the apparatus up toward them with the other hand (the direction of strain here is as indicated by the curved arrow in FIG. 6a). Alternatively, a user may flex the apparatus away from them. FIGS. 6C and 6C are intended to provide another example of such a tearing gesture which may be applied to such a deformable apparatus 10, where a user uses both hands to deform the apparatus 10.

In FIGS. 6A, B touch inputs 66a, 66b form a first set of one or more touch inputs applied by a user to the apparatus 10, whereas inputs 70, and 72a,b, c form a second set of one or more touch inputs applied by a user to the apparatus 10. In addition, a third type of touch input is generated by the strain resulting from the deformation applied to the device by the first and second inputs. First set of inputs and second set of inputs are separated by, and help define, the line of tear 100. In some embodiments, line of tear 100 determines the initial location of a tearing feature 100a which will be formed in a image 98 provided on a display responsive to the edge tearing gesture being applied by a user manipulating the apparatus 100, and may also define the direction the tearing feature essentially follows through the image.

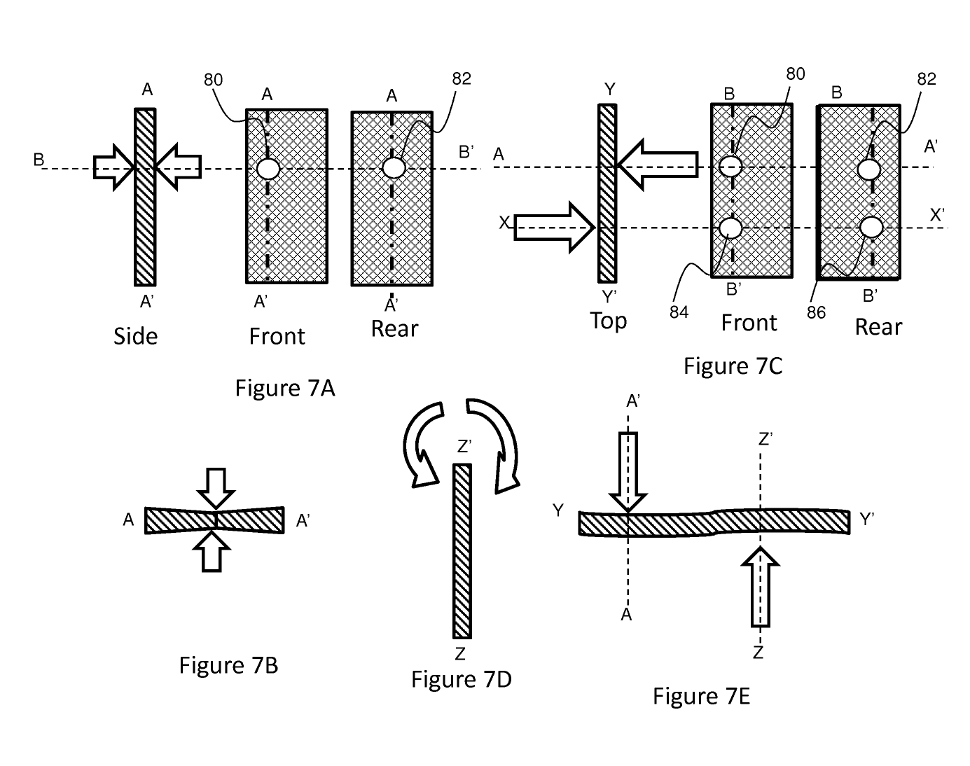

In this example, a user has grasped one part of apparatus 10 forming the second set of inputs 70, 72a,b,c and is moving that part of the apparatus 100 towards them, whereas the other part of apparatus 10 is being held down by the user's other hand which provides the other set of inputs 66a,b. This flexes the apparatus 10 which generates a strain on the structure of the apparatus 10. The strain is similar to a torque around the top edge Z′ of the apparatus 10 as shown by one of the arrows in FIG. 7D and as shown schematically by the curved arrow in FIG. 6A.

FIG. 6B shows how the second set of inputs comprise inputs 72a,b,c applied to the rear face of the apparatus 10. In this example, it is the collective movement of the first set of inputs relative to the collective movement of the second set of inputs which determines the force sensed by the strain sensors of deformable apparatus 10, however, in other examples, different relative movements of each set of inputs may produce strain in a different direction. The same line of tear 100 may be formed by a variety of different user grips and movements, depending on the way apparatus 10 is configured detect a tearing gesture has been applied using the strain and/or touch sensors of the apparatus 10. In some examples, touch inputs forming the first and/or the second set of inputs may include a compressive input element applied to the surface of the apparatus 10, and this compressive component of the touch input, in addition to the strain input, may be used to define attributes of the tearing gesture and accordingly, corresponding attributes of the tearing feature applied to the image.

FIGS. 6C and 6D shows schematically another example of an embodiment of the invention, where each hand of a user provides a set of touch inputs, such as may result, for example, from the type of touch inputs resulting from the gesture shown schematically in FIG. 9A, when the user grasps apparatus 10 and attempts to twist the apparatus along one edge to provide an edge tearing gesture. For example, in FIG. 6C, one set of touch inputs comprises the sensed touch input 70 to the front of apparatus 10, that is, for example, generated by a user's thumb when gripping the apparatus 10 and the inputs 72a,b,c may be sensed when the user's fingers grip apparatus 10 (as shown in FIG. 6D). Also shown in FIG. 6D, are another set of inputs being comprised of touch inputs 76a-d which correspond to the fingers of the hand which generates touch input 74 in FIG. 6C. In the example provided by FIGS. 6C and 6D, each set of touch inputs corresponds to a different hand of a user touching the apparatus 10. The number of inputs forming a set of inputs may vary, not just according to the number of digits a user employs to hold the apparatus 10 when the user flexes or otherwise deforms apparatus 10, but also according to whether a user's palm or fist for example may be detected and/or the number of digits a user has! In some examples, for each set of touch inputs, at least one touch input may be detected as being applied to a different surface of apparatus 10, to the surface to which the other touch inputs are detected on, thus necessitating the inputs to be near to an edge of the apparatus 10. In other examples, a compressive force may be detected between two opposing touch inputs due to the grip they exert on the apparatus 10. Collectively, such sets of touch inputs may be referred to herein as an edge input gesture, and as such, the edge input gesture shown in FIGS. 6A and 6B, and both edge input gestures shown in FIG. 6C to 6D, may be determined by the processing components of the apparatus 10 as forming examples of edge tearing gestures.

The edge tearing gestures may be determined from the edge input gestures and may have in addition to component(s) derived from one or more strain sensors of the apparatus 10, other component(s) derived from any detected pressure(s) of one or more of the touch inputs and/or components determined by the location of one or more or all of the touch inputs applied to the apparatus 10.

FIG. 7A shows schematically how two sensed touch inputs may deform apparatus 10 as shown schematically in FIG. 7B by applying compressional forces to opposing sides of the apparatus. FIG. 7C shows schematically how a sheering force or torque (see the schematic view shown of apparatus 10 in FIG. 7D) can be generated by two sets of touch inputs sensed as being applied to apparatus 10 and so deform apparatus 10 in a manner similar to that shown schematically in FIG. 7E.

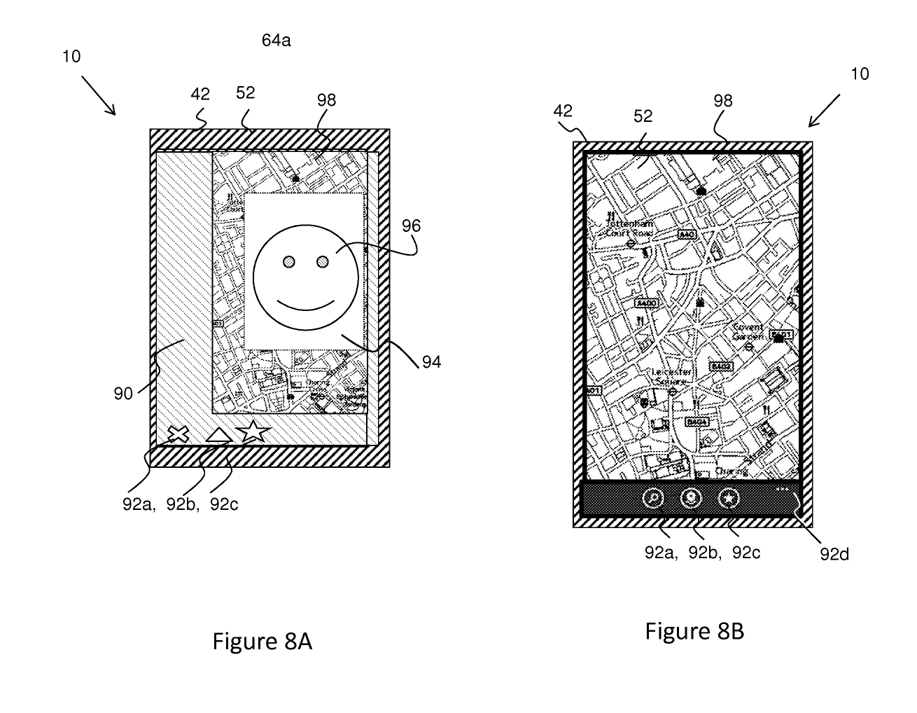

FIGS. 8A and 8B show schematically examples of screen states of a display 52 of apparatus 10 according to an example of an embodiment of the invention. In FIG. 8a, a foreground image 96 is superimposed on a background image 94 of a foreground window (or equivalent user interface display element such as a pop-up or the like) shown on display 52. The foreground window may be displayed over one or more background windows, for example, as shown another window which is presenting a map image 98, and/or a background or wall-paper image 90. Around the edge of the touch-sensitive display 52 shown in FIGS. 8a and 8b is non-touch sensitive region 42 which may form a frame or bezel. Also shown in FIG. 8a are examples of icons 92a,b,c which may launch applications on the apparatus 10, and similarly widgets and other graphical user interface elements may be provided on display 52 according to the state of apparatus 10.

FIG. 8B shows another example of a screen state of apparatus 10, in which a single foreground image 98 is displayed along with (optionally) user interface elements 92a,b,c,d.

Some examples of methods of image modification using one or more edge tearing gestures applied to image 98 shown on an example of deformable apparatus 10 according to some embodiments of the invention will now be described in more detail.

FIG. 9A shows schematically an example of how a user may grasp apparatus 10 and deform the apparatus 10 using an edge tearing gesture so as to generate a tearing feature 100a within image 98. A shown in the example of FIG. 9A, the tearing feature 100a propagates along a line of tear 100 (which in some embodiments is shown in image 98) determined from the characteristics of the touch inputs generated by the user's grip on apparatus 10 as they deform the apparatus 10 with an edge tearing gesture. The characteristics of the tearing feature may be derived by treating the touch inputs as forming two sets of inputs as were shown in FIGS. 6C and 6D, and determining the location and direction of the line of tear 100 in the displayed image 98 accordingly. In some embodiments, the image 98 is modified as the tearing gesture is applied along the line of tear 100 with tearing feature 100a so as to provide a visual indication of the effect of the tearing gesture on the image 98, and how the image 98 may be subsequently cropped.

In one example of an embodiment of the invention, the touch inputs detected are processed to determine strain components and/or touch and/or pressure components as appropriate for the tearing gesture. For example, based on the location characteristics of the determined touch inputs or collective sets of touch inputs, a location for the line of tear 100 may be determined and an initial tearing feature may be displayed in the image 98 to show the initial tear location. As shown in the examples shown in accompanying FIGS. 9 to 12, a short segment of the determined line of tear 100 may be visible as a trace image in the image 98, forming an extension of the tearing feature 100a. In other examples of embodiments of the invention, the line of tear 100 may not be visibly indicated in any form on the displayed image, or may be displayed only transiently in image 98 (for example, line of tear 100 may be initially shown with tearing feature 100a or as part of tearing feature 100a but may fade after a short predetermined period after tearing feature 100a is formed. In some examples, the line of tear 100 may be provided transiently to represent at least the initial location and at least an initial path segment which a tearing feature 100a will follow within image 98. The actual image modification is provided by the tearing feature 100a as shown in the image 98 and one or more visible tearing features 100a may visually partition the image so as to define one or more partitioned portions of the image 98. In some examples, one or more other characteristics of the tearing feature 100a displayed in the image 98 may be derived from one or more appropriate characteristics of the detected individual inputs and/or edge tearing gesture input. For example, the location and relative direction of movement of the touch inputs forming an edge tearing gesture applied to apparatus 10 may determine the initial start point and direction of movement of the tear feature 100a within image 98 and the speed of movement and/or the magnitude of the strain resulting from the movement of the touch inputs may be used to determine the speed and/or extent of the tear feature along the line of tear.

As shown in the example of FIGS. 9A and 9B, the initial start point of the tear feature 100a is located on the edge of the image proximal to the edge of the apparatus 10 where the edge tearing gesture was applied. The position of the tearing feature 100a along the proximal image edge is where the line of tear 100 intersects with the edge of the displayed image 98 (note if only a portion of an image is being displayed at any one time, this edge may not correspond to the true edge of the image (see FIG. 14 for example). The line of tear 100 the tearing feature 100a follows may, but need not always, be equidistant between the central location of the two edge gesture inputs which collectively represent the individual touch inputs applied to the touch-sensitive display. For example, in some embodiments of apparatus 10, the line of tear 100 may be located equidistant between the central location of the groups of inputs representing each hand gripping apparatus 10, in other embodiments, the line of tear may be dependent on just the location of the front sensed inputs or groups of inputs. In some examples of embodiments of apparatus 10, the apparatus 10 is configured with suitable rules to determine the initial location of the tear feature 100a. Some examples of embodiments of apparatus 10 may be configured with suitable rules which determine which image on apparatus 10 a tearing feature is to be applied if more than one image is displayed when the edge tearing gesture is applied to apparatus 10. For example, one possible rule to be applied when determining the location of the line of tear 100 may comprise determining the aggregate distance between the two sets of inputs sensed on the front of apparatus 10 (which may take into account the area of any touch inputs such as that caused by palms of the hands resting against the surface of apparatus 10) and adjusting this difference according to any difference in pressure applied by either input (if any pressure is sensed) to determine the position and orientation of the line of tear through image 98. Similarly, whether the tearing gesture is to be applied to the outmost edge only of the foreground image or any foreground image in a currently active window may be configured.

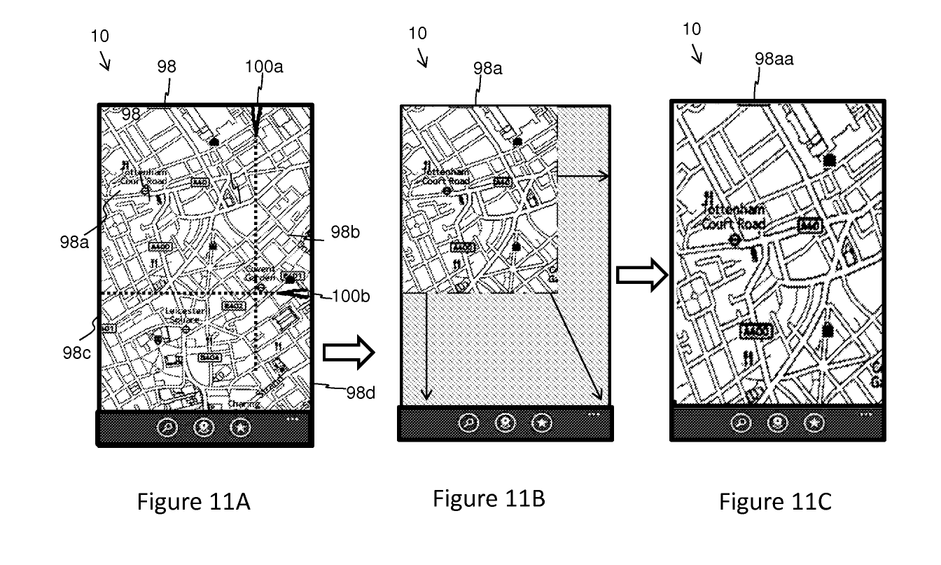

In some examples, the size and/or direction of propagation of the tearing feature 100a formed in image 98 may be changed dynamically to provide feedback to the user during the tearing gesture. This may indicate if a prolonged tearing gesture or additional tearing gesture or other input may be required to extend the length of the tearing feature along the line of tear to fully partition the image 98, although if more than one separate tearing gesture is to be applied (see FIGS. 11A, B, C, and 12A, B, C, described in more detail herein below), an image portion may be provided without a tear gesture necessarily propagated fully across the displayed image 98.

To extend an initial tearing feature to tear more of the image 98, for example, the initial gesture may be repeated to cause the tear to further propagate in the same direction or alternatively, a user may change to use another form of input, including another touch input or touch gesture such as FIG. 9B shows, where a user can drag a portion of the tearing feature displayed in image 98 to elongate the tearing feature in the image. For example, as shown in FIG. 9B, a user may drag the tip of the initial tearing feature formed responsive to an edge tearing gesture in the direction of the arrow shown to the lhs of apparatus 10 FIG. 9B and so to cause the tear feature 100a to propagate further into the image along the line of tear 100. Such dragging input may be provided by a user's digit or any other suitable touch input element.

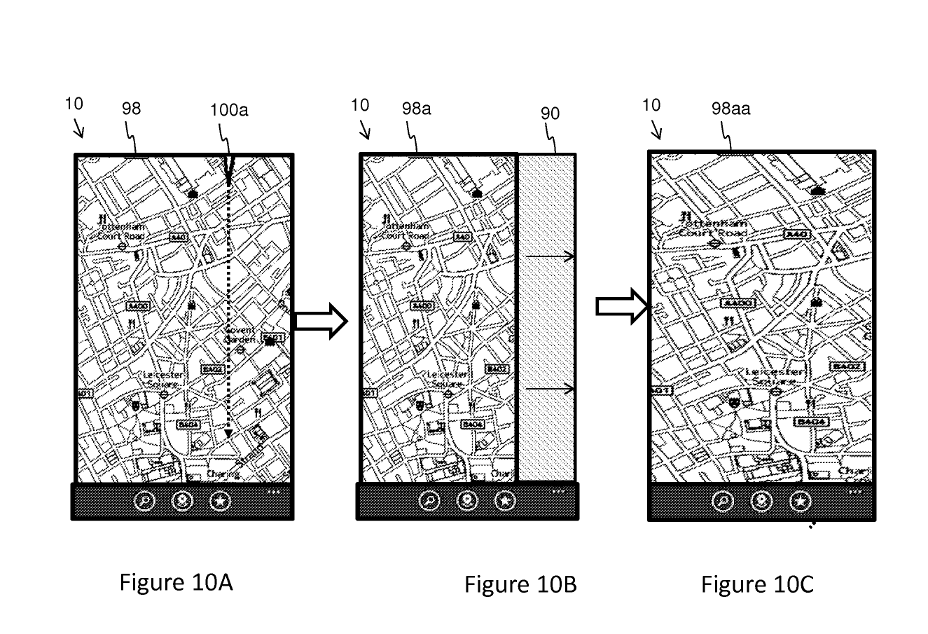

One example of image modification according to an embodiment of the invention will now be described with reference to FIGS. 10A to 10C of the accompanying drawings. In FIG. 10A, a tearing gesture has been applied which has caused a tear feature 100a to be extended along a portion of the line of tear 100 to form a trace which is visibly displayed to delineate the extent and direction of a tear resulting from an edge tearing gesture applied to the image 98 which occupies a first region of the display 52 of apparatus 10.

In FIG. 10B, the tearing gesture has propagated fully across image 98 to partition the image 98 into two portions 98a (shown) and 98b (not shown). One of the two portions is selected to be retained, either by selection one portion of the partitioned image to be removed or by selecting the portion which is to be retained. In this example, the left-hand side image portion to the tear formed across the image 98 by the tearing feature 100a forms the retained image portion 98a. In some examples, the retained image portion 98 may be subsequently scaled. The scaling may be automatic to expand the retained image portion to fill a predetermined area on display 52, such as the area previously occupied by image 98. Alternatively, further user input may be required, in addition to the input selecting an image portion is to be retained, or alternatively, in some embodiments, the retention and scaling to a desired size of the retained image portion may be combined. For example, a short tap may select an image portion to be retained. Then, as FIG. 10B shows, the display will show only the retained image portion which will not fill the original area on the display occupied by the image 98. The retained image may subsequently be enlarged by subsequent user input, for example, a swipe or dragging gesture, such as FIG. 10B shows using arrows, to indicate that the retained image portion should be magnified to occupy the region on the display previously occupied by the original image. Alternatively, the duration of long tap or press or the extent of touch input provided by a swipe or a dragging gesture may be used to determine the extent of magnification of the retained image portion, which may be up to the edge of the display. Any appropriate input may be used however, to enable the retained portion 98a of the partitioned image to be scaled appropriately to provide a scaled image portion 98aa which now also occupies the same size of region of the display 52 as was occupied by the image 98 before the tearing gesture was applied as the example shown in FIG. 10C. In some examples, the retained image portion is not be scaled, however, or as mentioned, the scaling applied may be responsive to a user input gesture. For example, a circular touch input gesture may be applied to select a image portion to be retained and at the same time, the amount of rotation of the selection gesture may indicate the desired size for the retained image to be scaled to and occupy on the display. Other such gestures which may both select an image portion to be retained and indicate to some extent the desired are on the display the retained portion is to occupy include a swipe gesture where the extent of the swipe determines the scaled size of the retained image portion on the display, and a user may also drag a corner or edge of the retained image portion to expand the image's size on the display.

Whereas FIGS. 11A to 11C show schematically another example of image modification according to an embodiment of the invention which an image is to be re-sized only after two tearing gestures 100a, 100b have been applied to apparatus 100 (see FIG. 11A). It is possible, as was shown in the example of image modification shown in FIGS. 10A to 10C, in which a user applied a tearing gesture to generate a tearing feature 100a in the image 98 in a first direction along line of tear 100a, to then select to retain an image portion 98a (or equivalently discard an unwanted portion 98b), to simply repeat the tearing gesture and image portion retention to further crop the previously retained portion 98a of the image by now tearing but in another direction along the line of tear 100b, and discarding unwanted portion 98c of FIG. 11A.

Alternatively, as shown in FIG. 11A, two edge tearing gestures may be applied consecutively and without selecting to retain an image portion in between (i.e., and not after the first edge tearing gesture was applied, eliminating the need to select an image portion to retain twice).

For example, as shown in FIG. 11A lines of tear 100a, 100b are first generated after two tearing edge gesture inputs are applied to apparatus 10 to partition the image into four image portions 98a, 98b, 98c, 98d before any image portions are discarded. In this example of an embodiment of the invention, a user selects after applying the two edge tearing gestures to the apparatus 10, which image portion 98a they wish to retain. The retained image portion 98a may then be scaled automatically to form a scaled image portion 98aa which occupies the same region of the display 52 previously occupied by the original image 98 (see FIGS. 11B and 11C). As previously described for the embodiments shown in FIGS. 10A, B, C, again some touch input gestures may be used which identify not just which image portion is to be retained but also to indicate to what extent the image portion is to be scaled to increase the size of the region on the display the image occupies. As describe previously, examples of such dual-purpose gestures may include a swipe or circular gesture applied to a particular image portion, or dragging the image portion to expand its size. Such dual-purpose gestures according firstly indicate that the portion to which the gesture is applied is selected as the retained image. Secondly, they indicate that the selected image portion is to be scaled by an amount indicated by the extent of the touch input (for example, the extent of the drag or swipe gesture or the rotation of any circular input so that the size of the image on the display is enlarged by an amount dependent on the input). Another type of dual-purpose gesture may be provided by a long press where the duration of the pressure which could indicate the image should be scaled instead to completely fill the available space on the display and/or the area on the display previously occupied by the original image to which the tearing gestures were applied. Alternatively, apparatus 10 may be configure to perform default scaling when the retained image portion is selected, so that by tapping on the image portion to be retained, it is automatically scaled to the same size of area on the display as the size of area occupied by the original image portion.

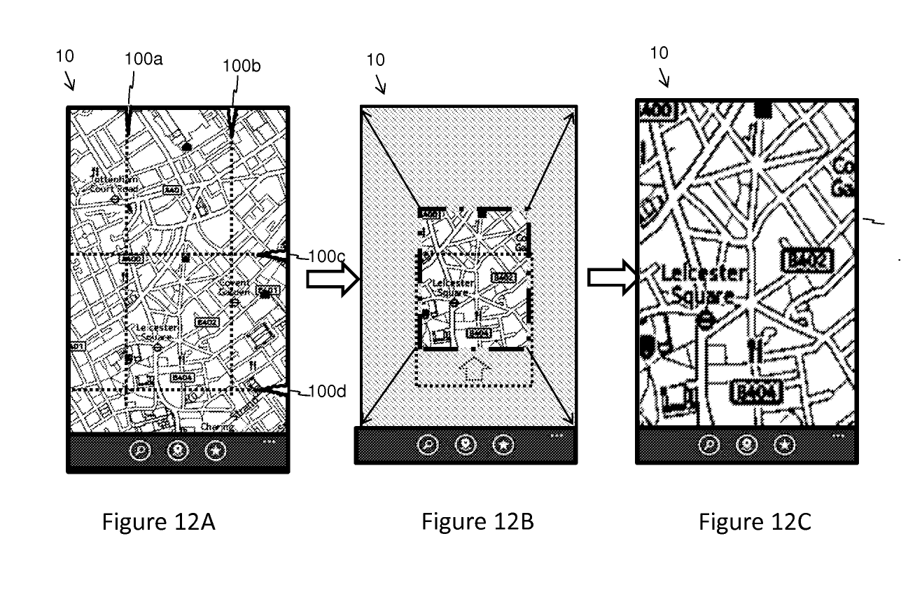

FIGS. 12A to 12B show yet another embodiment of the invention which is similar to that shown in FIGS. 11A to 11B but where the user does not select which image portion to retain after the second tearing gesture but instead waits until all four tearing gestures 100a, 100b, 100c, 100d have been applied to the device.

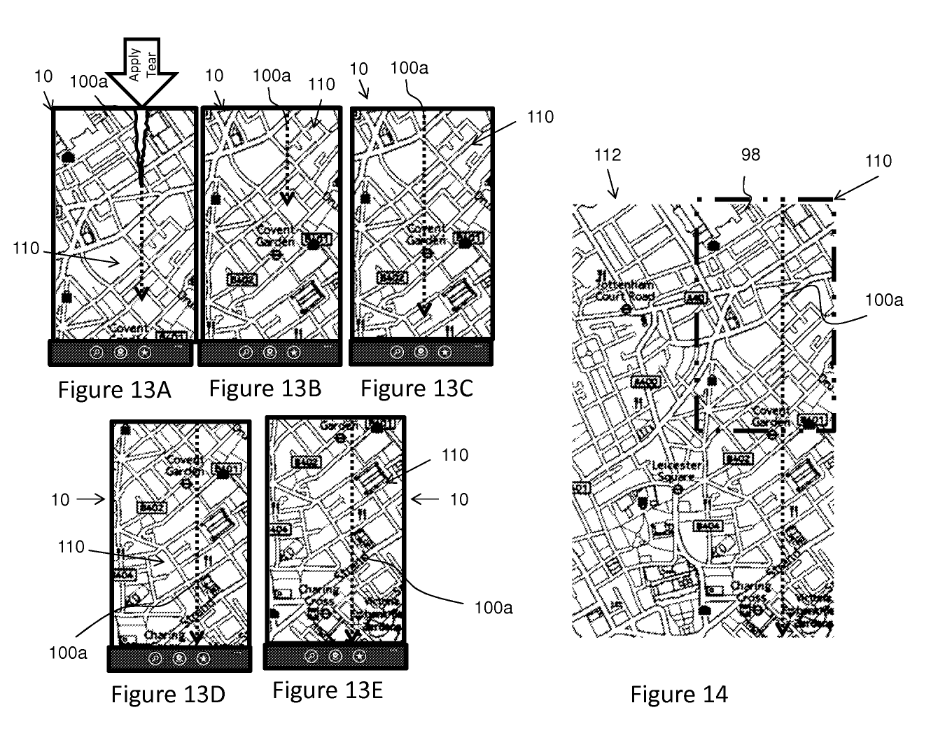

FIGS. 13A to 13E, and FIG. 14 show schematically an example of how a tear feature may be applied to an image 112 comprising only an initially displayed portion 110 using an edge tearing gesture according to an embodiment of the invention. In FIG. 13A, the size of the image 112 to be manipulated using tearing gestures is larger than the available area on display area, and so only a portion 110 of the image 112 is capable of being displayed at any one time.

As shown in FIG. 13A, an initial tear feature 100a is applied to image 112 and is elongated along the line of tear 100 so that FIGS. 13B,C,D and E show further propagation of the tearing feature 100a through the displayed image portion 112 of image 110. The tear feature 100a may be elongated using additional touch input(s), comprising, for example, the tearing edge gesture input which caused the initial tear feature to form on image 112 being sustained or increased in force, or repeated, or due to additional input such as may be separately provided by dragging the tearing feature downwards. The image 110 in which the tearing feature is propagating is also scrolled so that a user can extend the tearing feature in the image to partition the image according to the desired extent, for example, if they wanted to partition the image 98 into two portions.

FIGS. 13B to 13E show how the image portion 112 shown on the display 52 is updated. These figures shown the image portion 112 scrolling on the display as the tearing feature 100a propagates further along the line of tear 100. In some embodiments, suitable scrolling of the image 110 and tearing feature 100a may be automatic as a result of the edge tearing gesture applied, for example, as a result of the size of the determined tearing force applied by the tearing touch gesture detected. Alternatively, as was also mentioned above regarding FIG. 9B, a user may instead drag or swipe a portion of the initial tearing feature shown in the image to define a line of tear and to cause the tear to propagate along the direction of the user's image, and this may result in a panning and/or scrolling action as appropriate (the tearing feature is shown generated along a downwards direction along the initial line of tear as shown in FIGS. 13A to 13E by way of example only). The image and tearing gesture may scroll at the same rate responsive to the detected tearing gesture or at a slightly modified rate(s), if another effect is applied to the image being torn, such as, for example, if the image is reduced to a smaller scale to enhance its scroll rate. In another embodiment, a user may hold down the tip of the tearing feature and then use other touch inputs to swipe the background image only to cause it to scroll and for the tearing input to propagate in the image accordingly. It is also possible, in some embodiments, for the tearing gesture to scroll inertially across the screen in response to an initial swiping gesture starting from the tip of the initial tearing image feature generated in response to the initial tearing gesture detected. Alternatively, the image “tear” may propagate as repeated tearing gestures are detected. All references to scrolling this context may include panning or laterally scrolling the displayed portion 112 of image 110, depending on the direction the tearing feature 100a propagates in within image 110.

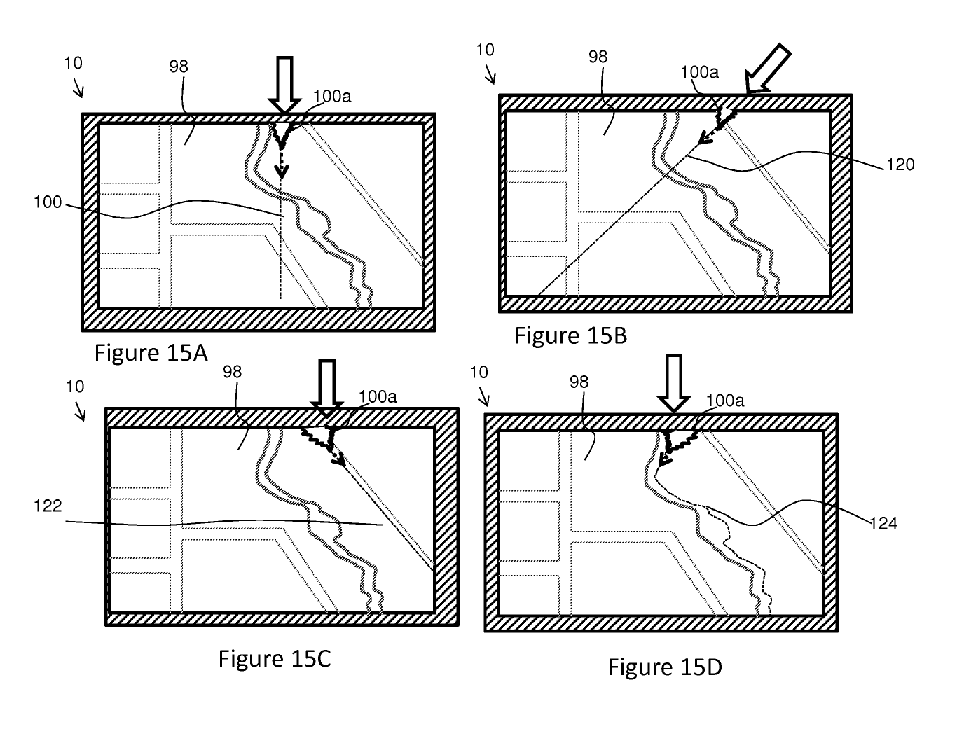

Whilst in the above embodiments, the tearing features shown in the images have been generally described as following the initial line of tear generated by the tearing input edge gesture, and as such applied in a straight line. As shown in the examples of embodiments of the invention in FIGS. 9A to 14, this direction is determined by the direction of the initial tearing force gesture detected and as such is shown as being transverse to one edge of the image 98 and/or apparatus 10 and parallel to another edge of image 98 and/or apparatus 10 (such as FIG. 15A shows schematically). However, in other embodiments of the invention, the line of tear 100 that the tearing feature 100a follows is not transverse or perpendicular to the edge of the apparatus. For example, it is also possible for a user to apply an edge tearing gesture in a direction which produces a strain which is not transverse or perpendicular to an edge of the device, such as FIG. 15B shows schematically, where the resulting line of tear 120 is oblique to the edge of apparatus 10.

In some examples of embodiments of the invention, the displayed image to be manipulated by the edge tearing gesture applied to apparatus 10 comprises one or more internal features forming regions in the image with defined border(s) or edge(s). For example, a text document and/or a cartographic or photographic image or drawing may have features which define edges along which a user may wish to tear the image. One example of such an image is a map having contour lines, lines of latitude and longitude, rivers, roads, railways, etc., etc. such as are shown in FIGS. 15 A,B,C and D. Some examples of an embodiment of the invention enable a user to configure a setting to be applied when an edge tearing gesture is detected. In some examples, the initial edge tearing gesture applied defines only an initial starting point of for the tearing feature in the image, and the tearing feature then subsequently propagating along of the feature(s) in the image 98 proximal to the initial tearing feature as determined by one or more user-configurable settings.

FIGS. 15C and 15D show some further examples of how user-configurable settings can determine the features along which a tearing feature propagates in an image 98. In FIG. 15C, a user-selectable setting enables the initial tearing feature to subsequently follow a line of tear 122 which is defined by the nearest road. When such a setting is configured to be active, when the initial tearing feature is located initially at a location determined by where the edge tearing gesture is applied to the apparatus 10, but subsequently the tearing feature propagates along the road feature in the image in closest proximity to the location where the initial tearing feature is shown in the image. In FIG. 15D a user-selectable setting instead configures the initial tearing feature to propagate subsequently along a line of tear 124 which follows the edge of a river feature depicted in image 98. Alternatively, in some embodiments, a user may generate an initial tearing gesture, but then tap on a nearby feature which provides an edge in the image which then provides a suitable line of tear along which the tear feature can then propagate. Further touch input then expands the tearing feature along the line of tear the user as selected in the image.

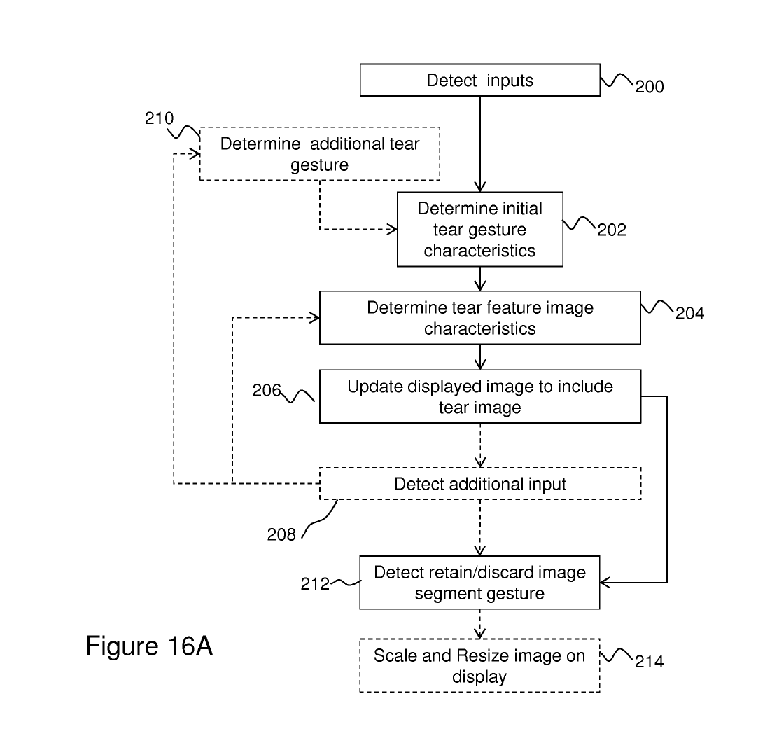

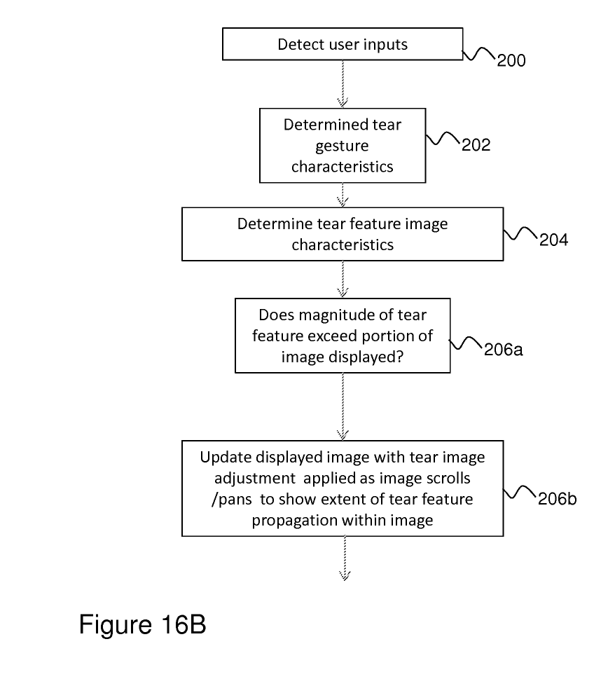

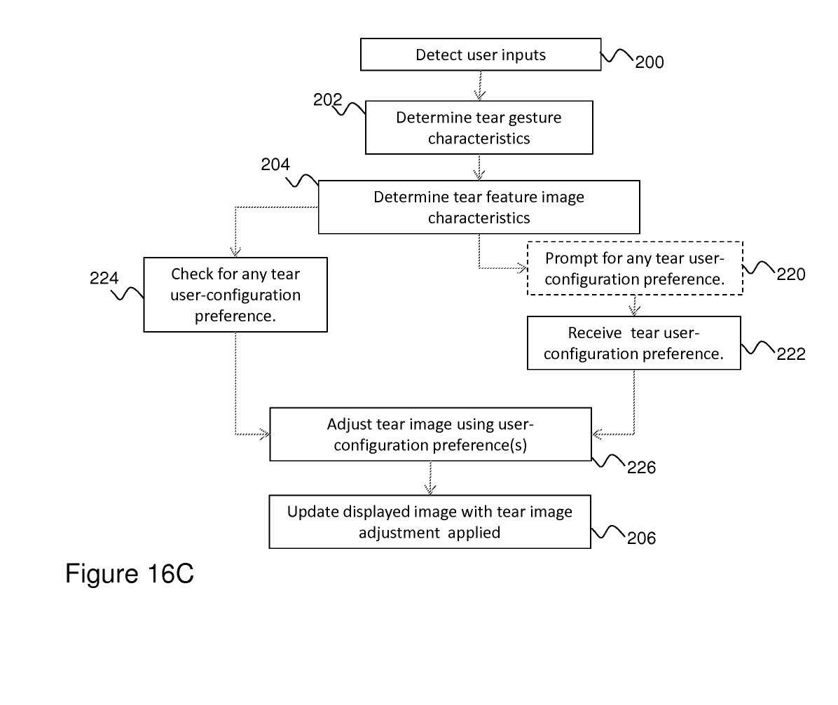

FIG. 16A shows some steps in an example of a method of image modification according to an example of an embodiment of the invention. In FIG. 16A, the user interface of the apparatus 10 detects touch inputs (step 200) which may include inputs producing a strain on apparatus 10 forming an edge tearing gesture. The inputs are suitably processed to determine the characteristics of the edge tearing gesture applied to the apparatus 10 (step 202). In some examples of the method, the detected touch inputs may be processed to allocate inputs to a set of inputs, and to determine if one or more sets of touch inputs have been applied. In some examples, from the characteristics of the sets of touch inputs, such as the strain produced by the inputs, the presence of an edge tearing gesture and the characteristics of the edge tearing gesture may be determined. For example, the detected touch inputs may comprise both sensed touch inputs to the touchscreen surface and strain sensed touch inputs associated with the forces applied to the apparatus 10 as a whole as a result of user manipulation of apparatus 10. In some examples, the touch and strain characteristics of the sensed inputs may be determined to form an edge tearing gesture if they meet certain criteria (for example, a strain exceeding a threshold value around an edge of apparatus 10, and then the characteristics of each set of inputs may be determined and used to determine the characteristics of the edge tear gesture (step 202). Once the characteristics of the edge tear gesture are known, they may be used to determine the characteristics of the tear feature 100a to be applied to image 98 displayed on apparatus 10 (step 204), such as the initial start position, direction, and magnitude of the initial tear feature 100a to be applied to the image 98. The form that the tearing feature takes may be any suitable form, for example a dotted line, arrow, v-shaped segment, jagged segment, which may be provided in, for example, a contrasting colour. The tearing feature 100a may also be provided in an animate form in image 98 in some embodiments of the invention.

In some embodiments, the image to be manipulated is automatically determined as the foreground image in a foreground window, for example, the image previously selected by a user to be an active or foreground window on apparatus 10. However, an edge tearing gesture having certain characteristics, such as when the device is in an idle state, may instead form a tear feature on the image of the user interface displayed in an idle mode of the device (the wall-paper may be torn, and certain UI elements may be “torn” to delete them, or nudged to one side or the other of the tear formed, so they may be selected to be retained, or discarded after the UI idle screen image is torn.

Responsive to the initial edge tearing gesture being applied by a user to the apparatus 10, the displayed image is updated to show the tearing feature 100a applied to the image 98 (step 206). In some embodiments, the image may be updated to show it is being torn by the tearing feature 100a dynamically as the tearing gesture is applied or is continued to be applied or is repeatedly applied. For example, the image of the tearing feature 100a may be dynamically updated in image 98 as a result of additional input (208), including additional input determined to form additional tearing gesture input 210. Once the image has been sufficiently partitioned by the tearing feature or tearing features, a user may select to either retain a portion of the image or a user may select to retain a portion by selecting to discard unwanted portions of the image on the display (step 212). In some examples of the method, the retained image portion is selected using a gesture that also determines that the image portion is to be scaled either to a predetermined size on the display or to a size determined by a characteristic of the selection gesture. In some examples, once a retained image portion 98a has been scaled appropriately (step 214). I some examples of the method, the retained image portion may be selected by a user tapping a portion of the image 98 to select the tapped portion to form the retained image portion 98a. The retained image portion 98 is then automatically scaled and resized in step 214 to occupy the same area on the display as was originally occupied by the image 98. However, in some examples, the retained image portion 98a may be scaled to occupy a larger or smaller area on the display 52 than was occupied by the image 98. The scaled and resized image portion 98a then may then be considered to form a region of interest to the user.

As mentioned previously, some examples of detected additional input (208) include input provided by continuing the duration of the initial tearing gesture (210), or by repeating the initial tearing gesture (210) or providing some other form of additional input to extend the initial tearing feature. For example, the user may, in one embodiment of the invention, provide such another form of additional input by selecting a portion of the tear image formed on the device, and afterwards dragging this in the direction they want the tear to form. In this way, a free-form tear may be applied by dragging the tear to form a curve etc., rather than a straight line. Alternatively a user may tap on the tear and then tap on a region of the image to form a tear between the two points. If the additional input detected is not additional tearing input to provide a tearing modification to the intimal tear formed on the image, for example, if the next touch input is a short press applied to one side of the tearing feature, it may be determined to indicate that the image segment on that side of the tear is to be discarded, in which case, the image will automatically resize to full the space previously occupied by the original image before the tearing gesture was applied.

FIG. 16B shows some steps in a method of image modification according to another embodiment of the invention, in which the image to be torn by an edge tearing gesture is scrolled as the tear feature produced by the edge tearing gesture propagates across the image. As described above for FIG. 16A, when the apparatus 10 detects certain user inputs (step 200) form an edge tearing gesture having certain characteristics (202), one or more of the characteristics of the tearing feature to be applied to an image 98 shown on a display of apparatus 10 are determined from the one or more of the characteristics of the applied edge tearing gesture (step 204). In the case where only a portion 112 of an image 110 is shown on the display 52 when the edge tearing gesture is first applied, if the edge tearing gesture has characteristics would result in the initial tear feature propagating along a line of tear extending into the portions of the image 110 which are not displayed when the tearing gesture was applied (step 206a) (for example, if the amount of strain applied by deforming apparatus 10 detected by the strain sensors of the apparatus is sufficiently large), the image 110 may be suitably scrolled on the display 52 in the direction of the line of tear 100, 120, 122, 124 that the tearing feature 100a will follow to show the propagation of the tearing feature within the image 110 beyond the initially displayed image portion 112.

Accordingly, when the sensed edge tearing gesture produces a tearing feature 100a which exceeds the visible portion 112 of the image 110 displayed, providing the image 112 being torn by the tearing gesture can be extended in the direction of scroll (and by scroll, this should be considered to include panning and/or any combination of panning and/or scrolling) beyond the portion 112 displayed when the tearing gesture is begun, the display may suitably scroll the image 110 as the tearing feature is applied to the image (step 206b). Additional input may be provided and/or other sequential tearing gestures may in this case be also applied in another direction after the tear is completed (see for example, FIGS. 11 A,B, C and FIGS. 12 A,B,C), and the method may subsequently follow steps 208 etc., as shown in FIG. 16A.

FIG. 16C shows schematically some steps which may be performed in another example of a method of modifying an image 98, 110 using an edge tearing gesture provided by manipulating apparatus 10 according to an example of an embodiment of the invention. In this example, a line of tear is 100, 120, 122, 124 which the tearing feature 100a produced in the image 98 follows in the image 98, 110 not determined solely from the characteristics of the detected edge tearing gesture input.

In FIG. 16C, a user provides input to apparatus 10 (step 200) which is determined to be an initial tearing gesture (step 202). The user input which is determined to provide a tearing gesture is then processed to determine characteristics of a tear feature to be applied to an image 98 or 110 provided on the display 52 of apparatus 10 (step 204).

FIG. 16C shows how, in some examples of embodiments, a check is performed at step 224 to see if a user has previously selected any preferences for the line of tear along which a tear feature propagates within image 98, 110. Examples of such preferences include, that the line of tear should follow a particular edge of a region or object shown the image 98, 110. Examples of regions or objects include lines of text, or the blank regions between lines of text, cartographic or topological features (for example, a country or regional border, or a geographic feature such as a contour line, a railway, river or road or line of latitude or longitude). In one example of a method of image modification according to an embodiment of the invention, upon detection of, or during, or shortly after, the edge tearing gesture being applied, for example, before the screen visibly updates on display 52 to show the tear feature 100a propagating in the image, a check is performed to see if any settings have been configured for the line of tear 100, 120, 122, 124 and if so, if they should be applied to modify the way the tear feature 98a resulting from the detected tearing gesture is shown propagating within the image 98. In some examples, the check may determine if the image 98 is a type of image which is normally associated with certain image features for which a line of tear settings may be activated. In some examples, the image type and its feature contents may be provided by meta-data, or alternatively, the image and its contents may be processed to present a suitable range of settings for the line of tear.

For example, consider when an image 98 comprise a map such as was shown, for example, in FIGS. 15C and 15D. Examples of setting which may be applied automatically or which a user may be prompted to apply include a setting which indicate certain types of images, and such as apply the settings only to the images which conform with that type of image. For example, a setting may indicate that only if an image is a map, are certain other settings to be applied. The image 98 may be identifiable as a map from meta-data associated with the image.

Examples of a setting for a map image include a setting to indicate that a tearing gesture applied to an image of a map should propagates along any cartographic feature in the map image or just along one or more specific types of features (e.g., to apply tears to propagate along a nearby nearest road, or lines or latitude or longitude, but not along contour lines, country boundaries, rivers, or mountain ranges for example).

Another example of a setting for a type of image may be configured for a user interface (UI) type of image which provides user-selectable options to partition the UI image only between graphical user input elements of the user interface (i.e. between rows or columns of icons or widgets) so as to preserve whole graphical user input elements in the user interface image (i.e. so as to not end up with just half a widget or icon being shown on a display).

Another example of a setting may cause a tearing feature formed in any type of image to not propagate in a straight line determined by the detected characteristics of the edge tearing gesture but instead to follow a feature present in the image or to follow user input. A user may select to perform a trace operation when they extend the tear by dragging the tip of the tear along the feature the tear is to follow, or provide such a trace on the image and then applied the tearing gesture in its vicinity.

FIG. 16C also shows how, in some examples of embodiments of the invention, after the initial tearing gesture has caused a tearing feature 100a to be shown in image 98, one or more user selectable options may be displayed for configuring if the tearing feature 100a should propagate along a line of tear formed by an edge of a nearby feature in the image (as shown for lines of tear 122, 124 in FIGS. 15c,d rather than along a straight line of tear 100. Such option(s) may be generated dynamically as the tearing gesture is being generated so that the user can select feature(s) present in the image near to the tearing feature which the tearing feature would, if the option was selected, then propagate along. Alternatively a user may be prompted to touch at least a portion of the edge of a image feature they wish the tearing feature to propagate along. The image is then updated to show the tearing feature (step 206), after which the user may select to retain a portion of the image partitioned by the tearing feature and/or to automatically remove the unwanted portion of the image. The image may then be resized appropriately as previously described, and after resizing form an area of interest.

In the above embodiments, references to tearing gestures include references to edge tearing gestures which apply strain about an edge of apparatus 10. The retained image portions, once re-sized and/or scaled by a user, may, in some embodiments, form a region of interest.

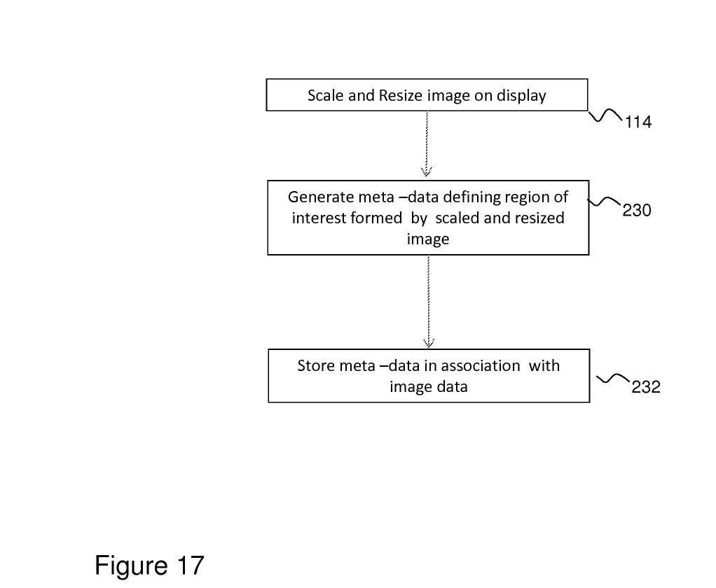

FIG. 17 describes some steps in a method of image modification according to an example of an embodiment of the invention in which, after a retained image portion has been suitably scaled and resized (step 114) on the display 52, it is either automatically designated a region of interest, or, in some embodiments, a user is prompted to designate the area as an area of interest. Once a manipulated image has been designated as a region of interest meta-data is generated indicating the portion of the original image 98 now forming the region of interest (step 230). Such meta-data may also designate any scaling or level of magnification applied to the image to form the region of interest, including the size of the image on the display). In some embodiments, an indication of the display characteristics may also be captured as meta-data to facilitate subsequent viewing of the area of interest on other display apparatus. Storing the meta-data, for example, in association with the data file from which the original image 98 was generated, enables the subsequent retrieval of the region of interest of the image when the image file is selected automatically and without a user needing to reapply any tearing gestures or otherwise crop and scale the image (step 232). Once such meta-data is generated and saved in some embodiments of the invention, it sets the region of interest as the default image shown when the data file providing the original image is selected instead of the original image.

In some embodiments, the meta-data is associated with the image file data so that if the same image is selected, instead of the original image shown on the display, only the portion of the image provided at the same scale of resolution and size as that of the region of interest formed by the edge tearing gesture(s) applied to the original image is displayed. A user can thus quickly retrieve the specific region of interest when reselecting that image for display. Alternatively, in some embodiments, a user may which to save the region of interest as a separate data file, however, this can increase the amount of image data stored on the device, and is not necessary in some embodiments.

In some embodiments of the invention, where meta-data has been generated using an example of a method such as FIG. 17 shows, even though the default action when the image file is next opened would be to provide just the region of interest, the meta-data restricting the image displayed to just the region of interest previously selected is subsequently capable of being removed by the user selecting to restore the image to its full form. By removing the association of the meta-data defining a particular region of interest in the image, selecting to open the image file results in the original unrestricted image being displayed. In some embodiments, further regions of interest can be selected after an initial region of interest has been designated by the user using meta-data. In some embodiments, the meta-data may be permanently associated with the image file so as, for example, to provide a form of digital rights management for distributing the region of interest and/or the original image.

In some examples of embodiments of the invention, the meta-data provides a resolution value for the image size or other scaling information and, dimensions and location of the portion of the image to the displayed, and any other appropriate image characteristic information which is stored following the tearing gesture to ensure that the retained image portion forming the area of interest can be quickly and conveniently subsequently displayed. The meta-data defining an area of interest may limit the level of zoom that can be applied to the image.

Some examples of meta-data include one or more of the following: coordinates of the corners of the image retained, and/or the retained image on the display; zoom level at which the image was cropped; a map mode used for the region of interest image portion (normal, satellite, Terrain,); layer information for the region of interest image portion, such as the layer on top (transit, traffic information, points of interest), data file information, for example, version information, including for example, a map version used (Map data xx.yy.zz), information indicating the map scheme (car, pedestrian, etc.).

The above embodiments may improve the user experience for image modification by associating the edge gestures used to tear, for example, a sheet of material such as paper with a similar edge touch gesture which can be applied to a deformable apparatus 10 such as a flexible device. The apparatus so deformed by the gestures applied is not torn but the touch inputs and forces generated by the touch inputs sensed by apparatus 10 enable the characteristics of a tear which might otherwise be formed if the apparatus was such a sheet of paper, to be determined and applied to the foreground or most prominent image shown on a display 52 of apparatus 10.

In some examples of embodiments of the invention, the line of tear 100 formed in the image 98 and the line of tear determined from the edge tearing gesture location on the apparatus 10 are co-located at least at the initial point at which the image 98 is torn. In this way, a user can be provided with guidance as to whether the tear will be formed by where they apply the edge tearing gesture. However, in some embodiments, the image may not occupy a sufficient area of the device to be associated directly with the tearing gesture(s) applied by a user or be displaced on the apparatus 10. In such embodiments, when the tearing gesture applied to the apparatus 10 is detected, control signals generated by the strain sensors and/or touch sensors may take into account the location of the tearing gesture on the apparatus 10 and suitably adjusted the control signals generated to appropriate manipulate the foreground image and/or foreground window providing the image on apparatus 10.

The embodiments of the invention can be applied to manipulate a variety of types of images 98 capable of being displayed, including images of maps, photographs, documents, presentations, user interface (UI) screens including lock screens and home screens and other idle screens of the device, and elements of such screens such as wall-paper, and where possible, other application screens, and in some examples, composite images. Applying the edge tearing gesture to a UI screen may remove one or more user interface elements from the UI screen such as foreground user-selectable graphical UI elements such as, for example, icons and widgets from the displayed user interface screen. Applying the edge tearing gesture to, say a displayed document, may edit part of the document discarded by the tearing gesture and/or cause the document to be deleted (e.g. if two tearing gestures are applied in orthogonal directions to the document).

Some embodiments of the apparatus 10 comprise a fully touchable and deformable device capable of detecting pressure and/or strain applied to some parts of the device. In some embodiments, when an edge tearing gesture is detected by the apparatus, the edge tearing gesture input and/or the line of tear it generates is automatically passed to a predetermined application, which, responsive to one or more characteristics of the determined tearing gesture, applies a rip or a tear modification to an image being displayed on the device. In some examples of embodiments of the invention, the application may be a gallery application for viewing images.

In some examples of embodiments of the invention, the propagation of tearing feature in an image may be determined by a feature or edge in the image, such features and/or edges being determined by meta-data or by determining one or more of a gradient or difference in color, luminance, contrast, brightness between one or more regions within the image. Propagation characteristics may be set by a user so that a tear follows a direction determined by the tear gesture alone or “snap” to a feature of an image in close proximity to the initial tear generation gesture, such as a topological features shown in an image of a map, such as a river, stream, railway, road, path or other thorough-fare, a line of longitude, a line of latitude, a contour line, or for other images, any other appropriate type of image boundary (e.g. the edge of a column of text if the image shown is of a document). In some embodiments, the feature to snap to can be presented as an option on the screen to guide a user to the possible selection of the feature to snap to, or the user may configure a setting which defines what, if any, feature a tear induced by a tearing gesture should snap to.

In some examples of embodiments of the invention, the force of the applied tearing gesture may determine the size of an initial tear feature in the image and/or the speed at which a tear gesture propagates in the and/or the speed at which an image scrolls to show the tear gesture propagating in the displayed image. The force of the tear gesture could also be used to select which image is rendered with the tear feature on the device. For example, a strong tearing gesture may tear a home screen or a background image, for example, wall-paper of a home screen user interface, a gentle tear feature may tear the image UI itself. The straining force sensed by strain sensors within the apparatus may be used to determine the amount to which a tear propagates within a displayed image from the boundary in closest proximity to the tear gesture. If the straining force sensed generates a tear magnitude that would exceed the portion of the image displayed when the tear is applied, in some embodiments of the invention, the tear feature and the image may be scrolled to show the tear feature propagating within the image.

Although the above embodiments refer extensively to edge tearing gestures, an example of which is shown in FIG. 9A, in some examples of embodiments of the invention, it may be possible to use a tearing gesture such as FIG. 5 shows, and to use this to define an area of interest for which meta-data is generated in accordance with the example of the method of generating meta-data for an area of interest shown in FIG. 17. For example, such a tearing or sheering gesture may be used in a method in which a presentation of a first image provided by a data file is caused to be provided on a display. The displayed image may be modified by displaying at least one tear feature within the image responsive to detecting at least one tearing gesture, such as a sheering tearing feature shown in FIG. 5, which is applied to an apparatus. The image may then be partitioned into image portions using said at least one displayed tear feature. A selected one of said image portions may be retained on the display and the user may be presented with an option to generate meta-data to regenerate the selected image portion on the display. The meta-data may be configured to enable subsequent regeneration of said selected image portion from the data file used to present the first image. In this embodiment, apparatus 10 need not be deformable, but instead has a touchscreen display which must be able to determine from a plurality of touch inputs a suitable line of sheer.

The embodiments of apparatus 10 are implemented at least in part using appropriate circuitry. The term “circuitry” includes implementation by circuitry comprising a processor (or multiple processors) or portion of a processor and its (or their) accompanying software and/or firmware. Circuitry refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

In the above embodiments where meta-data is automatically generated to define an area of interest in a manipulated image, and a user has selected to associate the meta-data with the image file, the desired area of interest is presented automatically instead of the original image when the user next selects to view the image file. However, in some embodiments, although the user is presented with the area of interest initially, they may also be able to select an option to remove the designation of the area of interest by removing the meta-data that defines the region of the image file which forms the restricted area of interest. In this case, a user may view the original image and/or manipulate the image and apply a new area of interest. If no new area of interest is designated, selecting to remove the area of interest applied to the image removes the meta-data from association with the image file and enables the displayed image to revert back to its original form when subsequently the image file is selected for display.

Whilst the above examples of embodiments of the invention describe the deformable apparatus including a touchscreen display, in some embodiments, the deformable apparatus may be provided independently from a display showing the image to be manipulated using edge tearing gestures. In such an embodiment, deformable apparatus 10 functions as an input device sending control signals to the remote display apparatus.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-35. (canceled)

36. A method, comprising:
causing presentation of a first image on a display; and
causing modification of the displayed image by displaying at least one tear feature within the image responsive to detecting at least one edge tearing gesture applied to an apparatus.

37. A method as claimed in claim 36, wherein causing modification of the displayed image comprises;
partitioning the image into image portions using said at least one displayed tear feature; and
retaining a selected one of said image portions on the display.

38. A method as claimed in claim 36, further comprising scaling the retained image portion to the same size on the display as a presented size on the display of the first image, responsive to the selection of the image portion to be retained.

39. A method as claimed in claim 36, further comprising:
determining one or more characteristics of multiple touch inputs applied to said apparatus; and
determining one or more characteristics of a said edge tearing gesture from said one or more characteristics of said multiple touch inputs.

40. A method as claimed in claim 39, wherein one or more characteristics of said multiple touch inputs forming a said edge tearing gesture are detected at least in part by one or more strain sensors of the apparatus.

41. A method as claimed in claim 40, wherein the characteristic of the magnitude of strain caused by a said edge tearing gesture sensed by said one or more strain sensors determines the magnitude of said tear feature in said image.

42. A method as claimed in claim 39, wherein one or more characteristics of said multiple touch inputs forming a said edge tearing gesture are detected at least in part using one or more pressure sensors of the apparatus.

43. A method a claimed in claim 36, wherein a said edge tearing gesture comprises at least two touch inputs applied to opposing sides of said apparatus.

44. A method as claimed in claim 36, wherein the direction in which said tear feature propagates in the image is determined from characteristics of at least one said detected edge tearing gesture and/or at least one user-configurable setting.

45. A method as claimed in claim 36, wherein a plurality of said edge tearing gestures are sequentially applied to said image prior to retaining a selected image portion.

46. A method as claimed in claim 36, further comprising:
detecting at least one additional touch input after said edge tear gesture has caused said tear image feature in said first image; and
propagate the tear feature in the image responsive to the at least one additional touch input.

47. An apparatus comprising a processor and a memory including computer program code, the memory and the computer program code configured to, with the processor, cause the apparatus to:
cause presentation of a first image on a display; and
cause modification of the displayed image by displaying at least one tear feature within the image responsive to detecting at least one edge tearing gesture applied to an apparatus.

48. Apparatus as claimed in claim 47, wherein the memory and the computer program code are configured to, with the processor, cause the apparatus to cause modification of the displayed image by:
partitioning the image into image portions using said at least one displayed tear feature; and
retaining a selected one of said image portions on the display.

49. Apparatus according to claim 47 wherein the memory and the computer program code are configured to, with the processor, further cause the apparatus to scale the retained image portion to the same size on the display as a presented size on the display of the first image, responsive to the selection of the image portion to be retained.

50. Apparatus according to claim 47 wherein the memory and the computer program code are configured to, with the processor, cause the apparatus to:
determine one or more characteristics of multiple touch inputs applied to said apparatus; and
determine one or more characteristics of a said edge tearing gesture from said one or more characteristics of said multiple touch inputs.

51. Apparatus according to claim 50, wherein the memory and the computer program code are configured to, with the processor, cause the apparatus to detect one or more characteristics of said multiple touch inputs forming a said edge tearing gesture at least in part by one or more strain sensors of the apparatus.

52. Apparatus as claimed in claim 51, wherein the memory and the computer program code are configured to, with the processor, cause the apparatus to determine the magnitude of strain sensed by said one or more strain sensors and to determine the magnitude of said tear feature in said image in dependence on the sensed magnitude of strain.

53. Apparatus as claimed in claim 50, wherein the memory and the computer program code are configured to, with the processor, cause the apparatus to:
detect said one or more characteristics of said multiple touch inputs forming a said edge tearing gesture at least in part using one or more pressure sensors of the apparatus.

54. Apparatus as claimed claim 47, wherein the memory and the computer program code are configured to, with the processor, cause the apparatus to determine the direction in which said tear feature propagates in the image from at least one of:
one or more characteristics of a said detected edge tearing gesture; and
one or more user-configurable settings.

55. A computer program product comprising a non-transitory computer readable medium having program code portions stored thereon, the program code portions configured, upon execution, to:
cause presentation of a first image on a display; and
cause modification of the displayed image by displaying at least one tear feature within the image responsive to detecting at least one edge tearing gesture applied to an apparatus.
